(19) United States
(12) Patent Application Publication
(10) Pub. No.: US 2020/0096677 A1
(43) Pub. Date: Mar. 26, 2020

(54) OPTICAL SYSTEM

(71) Applicant: CSEM CENTRE SUISSE D'ELECTRONIQUE ET DE MICROTECHNIQUE SA - RECHERCHE ET DÉVELOPPEMENT, Neuchâtel (CH)

(72) Inventors: Ross STANLEY, Epalinges (CH); Amina CHEBIRA, Lausanne (CH); Liza Andrea DUNBAR, Saint-Blaise (CH); Pedram PAD, Lausanne (CH)

(21) Appl. No.: 16/471,824

(22) PCT Filed: Dec. 21, 2017
(86) PCT No.: PCT/EP2017/084158

§ 371 Date: Jun. 20, 2019

(30) Foreign Application Priority Data
Dec. 21, 2016 (EP) PCT/EP2016/082054

(51) Int. Cl. G02B 3/00; G02B 9/34

(52) U.S. Cl. CPC G02B 3/0068; G02B 3/0056; G02B 3/0012; G02B 9/34

(57) ABSTRACT

Optical system including at least one objective lens, an optical filter and an imaging lens or a first aperture array comprising a plurality of aperture elements. The at least one objective lens, the optical filter, and the imaging lens or first aperture array are arranged along an optical axis to form at least one projection of the optical filter on the imaging lens or on the first aperture array. The optical system further includes a filter selection means for selecting filtered electromagnetic radiation to be provided to the imaging lens or the first aperture array.

### FIELD OF THE INVENTION

This present invention concerns optical systems, for example, a snapshot hyper or multi-spectral optical system or an optical system for carrying out light intensity filtering or polarization filtering.

More particularly, the present invention concerns hyper or multi-spectral optical systems for obtaining image data, for example, in the spatial or in the frequency (Fourier) domain at a plurality of different wavelengths via a configuration in which a multiple wavelength filter array is repeated in a pixel like manner so as to filter different parts of an imaged object (in a similar manner to the known Bayer filter configuration), or via a configuration in which multiple images of an object are generated where each of the generated multiple images is filtered at a specific wavelength.

The present invention also concerns hyper or multi-spectral optical systems for obtaining multi-/hyper-spectral hypercube measurements of an object.

### BACKGROUND

A snapshot hyper/multi-spectral camera takes images at multiple wavelengths. There are many ways of organising the spatial and wavelength information on the detector or image sensor. The two most common configurations are to group the wavelength information in “super” pixels at the detector—this is the system used in a color camera with the well-known Bayer configuration (configuration A, FIG. 1g), or to group the spatial information together as multiple images on the detector where each image has a different wavelength (configuration B, FIG. 1h). Conceptually these two can be seen in FIGS. 1g and 1h.

In both configurations one challenge is the fabrication of the filters to achieve wavelength selection.

The filters can be either on or immediately in front of the detector, or they can be imaged onto the detector or they can simply block all parallel paths leading to the detector, which can be used in the case of an effective multicamera array, i.e. the system is set up as if it were an array of cameras but using a single detector.

If the filters are placed on or near the detector there are two issues, firstly the individual filters should be either the size of the pixel in configuration A (FIG. 1g) or the size of one of the images in configuration B (FIG. 1h) which can be very small or fixed, and secondly when the filters are placed near the detector the range of angle that the filter sees is the same as the numerical aperture of the camera. For sensitive cameras the numerical aperture is generally large leading to a wide range of angles on the filter. Filters such as standard narrow band filters are strongly angular dependent so this limits the linewidth of the filter.

To address these two inconveniences, the filter can be placed elsewhere and away from the detector. If the filters are placed elsewhere and reimaged onto the detector, there are at least two system configurations that may limit the number of filters.

In one system configuration, the filter is reimaged behind a microlens array to recreate configuration A (FIG. 1g), this is a filtered Plenoptics 1.0 configuration in terms of light field imaging. Here we call this system configuration A as the goal of this system configuration is to produce a super-pixel configuration as schematically shown in FIG. 1g. For comprehension reasons, this system configuration is shown to a limited extent in FIGS. 4 and 5, each part of an object 1 is imaged using two lenses (a first lens 2, and a second lens 3) onto part of a microlens array 4.

The microlens array 4 images an aperture 6 onto the detector. The filter can be put at the aperture stop 6, which allows an identical array of images of the filter to be made on the detector. The aperture stop 6 limits the cross sectional area of the bundle of rays from the object 1 to the image point. Here the aperture stop 6 at the focal point of the lens 2 controls the distribution of rays over the surface of lens elements of the microlens array 4 for the purpose of controlling the perspective of the object 1 allowing a telecentric scheme.

In the second system configuration in which a limited number of filters would be used, (here we call this system configuration B as the goal of this system configuration is to produce multiple images of the object as schematically shown in FIG. 1h), the microlens array 4 could be used to form multiple parallel images of an object, and the filter could be either placed just behind or in front of the microlens array 4. The multiple parallel images are each filtered at a specific wavelength by the filter.

The advantages of both of the above system configurations are that the size of the filters is not limited by the size of the detector, and the range of angles impinging on the filters can be made smaller by the same amount. The smaller angles incident on the filter permit an improved filtering function to be achieved. Additionally, it is less expensive to implement such a system compared to attaching individual filtering tiles onto a sensor. The filter is not located on the sensor and allows a large number of possibilities for locating the filter in the system as there is a flexible choice concerning the positioning of the filter in the system. Furthermore, the filter can be easy changed or replaced thus providing an adaptive system. Finally, only one filter is required and there is no absolute need to include multiple filters.

In all the above cases, the number of filters is the same as the number of wavelengths to be filtered and it is assumed that it is possible to make an array of filters, one for each wavelength. However, arrays of filters are both difficult and expensive to manufacture.

Moreover, it is also desired to provide a hyper or multi-spectral optical system for obtaining multi-/hyper-spectral hypercube measurements of an object.

### SUMMARY

It is therefore one aspect of the present disclosure to provide an optical system that overcomes the above inconveniences.

The optical system preferably includes
at least one objective lens;
an optical filter;
an imaging lens, or a first aperture array comprising a plurality of aperture elements;
   wherein the at least one objective lens, the optical filter, and the imaging lens or first aperture array are arranged along an optical axis to form at least one projection of the optical filter on the imaging lens or on the first aperture array, and wherein the optical system further includes a filter selection means for selecting filtered electromagnetic radiation to be provided to the imaging lens or the first aperture array.

This optical system advantageously permits multi-/hyper-spectral hypercube measurements of an object to be obtained.

According to one aspect of the present disclosure, the imaging lens or the first aperture array is arranged in the optical system to form at least one projection of an object to be filtered on a second aperture array or a second aperture array plane.

According to another aspect of the present disclosure, the filter selection means is configured to select a filtering zone or filtering zones of the filter to select the filtered electromagnetic radiation to be provided to the imaging lens or the first aperture array.

According to yet another aspect of the present disclosure, the filter selection means comprises a plurality of addressable areas configured to allow or block electromagnetic radiation through said areas to respectively allow or block electromagnetic radiation through the filter selection means.

According to another aspect of the present disclosure, the filter selection means is configured to define at least one or a plurality of patterns through which the electromagnetic radiation passes.

According to another aspect of the present disclosure, the filter selection means is configured to define a transparent band through which the electromagnetic radiation passes.

According to another aspect of the present disclosure, the filter selection means is configured to define a transparent band through which the electromagnetic radiation passes, and configured to define opaque areas or zones around the transparent band blocking the transmission of electromagnetic radiation.

According to another aspect of the present disclosure, the filter selection means is configured to define a transparent band through which the electromagnetic radiation passes, and configured to define opaque areas or zones around the transparent band blocking the transmission of electromagnetic radiation such that only the transparent band allows electromagnetic radiation to pass through to the imaging lens or the first aperture array.

According to another aspect of the present disclosure, the filter selection means is configured to displace or sweep the transparent band to permit spectrum sweeping.

According to another aspect of the present disclosure, the filter selection means is configured to displace or sweep the transparent band to carry-out a push-broom scan.

According to another aspect of the present disclosure, the filter selection means is located downstream from the filter, or is located upstream from the filter.

According to another aspect of the present disclosure, the filter selection means contacts directly or indirectly the filter.

According to another aspect of the present disclosure, the filter selection means comprises or consists solely of an electronically addressable optical device comprising a plurality of electronically addressable zones, areas or pixels configured to block or permit light transmission when addressed electronically.

According to another aspect of the present disclosure, the filter selection means comprises or consists solely of a spatial light modulator comprising a plurality of electronically addressable zones, areas or pixels.

According to another aspect of the present disclosure, the filter selection means comprises or consists solely of an electronically addressable optical device comprising a liquid crystal and a plurality of electronically addressable zones, areas or pixels containing liquid crystal material.

According to another aspect of the present disclosure, the filter selection means comprises or consists solely of a liquid crystal device or a Digital micro-mirror device.

According to another aspect of the present disclosure, the first aperture array is an array of image forming elements comprising a plurality of image forming elements.

According to another aspect of the present disclosure, the system further includes a second aperture array including an image sensor comprising a plurality of light sensing elements.

According to another aspect of the present disclosure, the optical system includes the first aperture array and the first aperture array includes an array of image forming elements comprising a plurality of lenses, micro-lenses or pinholes; and wherein the first aperture array is arranged in the optical system to form a plurality of whole or integral replications of an object on a sensor plane or sensor array; and wherein the filter is imaged to form the at least one projection on the first aperture array to filter the plurality of integral or whole object replications.

According to another aspect of the present disclosure, the optical filter comprises or is a mosaic filter including a plurality of individual optical filters.

According to another aspect of the present disclosure, each individual optical filter is configured to filter at a different wavelength.

According to another aspect of the present disclosure, the optical filter is configured to filter a plurality of different wavelengths According to another aspect of the present disclosure, the optical filter is configured to filter the same wavelength along a constant filtering direction of the filter.

According to another aspect of the present disclosure, the optical filter includes a filtering section, the filtering section defining an incident surface area, the filtering section including the constant filtering direction and being further configured to continuously filter at different wavelengths along a direction of the incident surface area following a vertical direction to the constant filtering direction.

According to another aspect of the present disclosure, a filtering section is further configured to continuously filter at different wavelengths along any direction or all directions non-parallel to the constant filtering direction across the incident surface area.

According to another aspect of the present disclosure, an optical thickness of the filtering section varies across the entire filtering section along said vertical direction or along said any direction or all directions non-parallel to the constant filtering direction, or across only a portion of the filtering section along said vertical direction or along said any direction or all directions non-parallel to the constant filtering direction.

According to another aspect of the present disclosure, the optical thickness of the filtering section varies continuously in a linear or non-linear manner, and/or varies according to a step-profile.

According to another aspect of the present disclosure, the filtering section includes a filter which varies in thickness.

According to another aspect of the present disclosure, the filter varies in thickness across all directions non-parallel to the constant filtering direction.

According to another aspect of the present disclosure, wherein the filtering section has an optical thickness constant across the entire filtering section along only one direction defining the constant filtering direction, and wherein said filtering section is orientated about the optical axis such that the direction of constant optical thickness of the filtering section is orientated at an angle relative to the array of image forming elements or relative to the image sensor.

According to another aspect of the present disclosure, the filtering section filters the same wavelength along the direction of constant optical thickness.

According to another aspect of the present disclosure, the filter is configured to filter different wavelengths along at least one direction non-parallel to the constant filtering direction along at least a portion of the filter.

According to another aspect of the present disclosure, the filter is configured to continuously filter at different wavelengths along the at least one direction non-parallel to the constant filtering direction along at least a portion of the filter.

According to another aspect of the present disclosure, the optical filter and/or the filter selection means are located upstream of the at least one objective lens, or in front of or behind or on the array of image forming elements or the imaging lens.

According to another aspect of the present disclosure, the optical filter and/or the filter selection means are arranged along the optical axis in an object space in which an object to be imaged by the system is located, or substantially at an object position at an object distance from the objective lens.

According to another aspect of the present disclosure, the system is a telecentric in image space and/or in object space.

According to another aspect of the present disclosure, the optical filter is or is defined by an image of an optical filter or a real image of an optical filter image.

According to another aspect of the present disclosure, the image forming elements of the array comprise lenses, micro-lenses or pinholes.

According to another aspect of the present disclosure, the optical system is a multi-spectral optical system or a hyper-spectral optical system.

Another aspect of the present disclosure concerns a device, such as a camera or smart phone, including the previously mentioned optical system.

According to another aspect of the present disclosure addressing the above-mentioned inconveniences an optical system includes
at least one optical projection element;
an optical filter configured to filter the same wavelength, intensity or polarization along a constant filtering direction of the filter;
a first aperture array comprising a plurality of aperture elements, a location of an aperture element on the first aperture array being defined by a first basis vector (or lattice vector) α₁ and a second basis vector (or lattice vector) α₂, the first basis vector α₁ extending in a first direction aligning a plurality of aperture elements of the first aperture array and the second basis vector α₂ extending in a second direction aligning a plurality of aperture elements of the first aperture array, the first basis vector α₁ and the second basis vector α₂ being orthogonal when the first aperture array defines a square or rectangular matrix of aperture elements;
a second aperture array comprising a plurality of aperture elements, a location of an aperture element on the second aperture array being defined by a third basis vector (or lattice vector) β₁ and a fourth basis vector (or lattice vector) β₂, the third basis vector β₁ extending in a first direction aligning a plurality of aperture elements of the second aperture array and the fourth basis vector β₂ extending in a second direction aligning a plurality of aperture elements of the second aperture array, the third basis vector β₁ and the fourth basis vector β₂ being orthogonal when the second aperture array defines a square or rectangular matrix of aperture elements;
   wherein the at least one optical projection element, the optical filter, the first aperture array and the second aperture array are arranged along an optical axis to form at least one projection of the optical filter on the first aperture array or on the second aperture array; or being arranged along an optical axis with the optical filter being placed in front of, behind or on the first aperture array; and
   wherein the constant filtering direction of the optical filter or the projection of the optical filter is orientated at an angle relative to the first basis vector α₁ direction; or wherein the constant filtering direction of the at least one projection of the optical filter is orientated at an angle relative to an axis defined by the third basis vector β₁ direction and relative to an axis defined by the fourth basis vector β₂ direction.

This optical system is a less complex optical system that is less expensive to produce while still allowing filtering and sampling at multiple wavelengths and allowing the range of angles impinging on the filter to be small permitting accurate filtering.

According to one aspect of the present disclosure, the third basis vector β₁ and the fourth basis vector β₂ placed tail to tail define an angular range in between the third basis vector β₁ direction and the fourth basis vector β₂ direction, and the constant filtering direction of the at least one projection of the optical filter is orientated with respect to the third basis vector β₁ direction and the fourth basis vector β₂ direction and orientated at an angle within the angular range or is orientated at said angle plus a positive or negative integer multiple of the angle between the third basis vector β₁ and the fourth basis vector β₂ placed tail to tail.

According to another aspect of the present disclosure, the constant filtering direction of the at least one projection of the optical filter is orientated at an angle within an angular range defined by a first angle θₘₐₓ produced by the vector addition of the third basis vector β₁ and the fourth basis vector β₂ and a second angle θₘᵢₙ defined by tan⁻¹(a1/b1) where a1 is half the magnitude of the vertical component of the fourth basis vector β₂ and b1 is the magnitude of the third basis vector β₁ multiplied by the total number of aperture elements along the third basis vector β₁ direction; or is orientated at said angle plus a positive or negative integer multiple of the angle between the third basis vector β₁ and the fourth basis vector β₂ placed tail to tail;
or the constant filtering direction of the at least one projection of the optical filter is orientated at an angle within an angular range defined by a third angle θₘₐₓ produced by the vector addition of the third basis vector β₁ and the fourth basis vector β₂ and a fourth angle θ1ₘᵢₙ defined by tan⁻¹(α₂/b2) where α₂ is half the magnitude of the vertical component of the third basis vector β₁ and b2 is the magnitude of the fourth basis vector β₂ multiplied by the total number of aperture elements along the fourth basis vector β₂ direction; or is orientated at said angle plus a positive or negative integer multiple of the angle between the third basis vector β₁ and the fourth basis vector β₂ placed tail to tail.

According to another aspect of the present disclosure, the angle between the third basis vector β₁ and the fourth basis vector β₂ placed tail to tail is substantially 60 or 90 degrees for a hexagonal or square/rectangular array respectively.

According to yet another aspect of the present disclosure, the constant filtering direction of the at least one projection of the optical filter is orientated at an angle relative to an axis defined by the first basis vector α₁ direction and relative to an axis defined by the second basis vector α₂ direction.

According to still another aspect of the present disclosure, the first basis vector α₁ and the second basis vector α₂ placed tail to tail define an angular range in between the first basis vector α₁ direction and the second basis vector α₂ direction, and the constant filtering direction of the at least one projection of the optical filter is orientated with respect to the first basis vector α₁ direction and the second basis vector α₂ direction and orientated at an angle within the angular range or orientated at said angle plus a positive or negative integer multiple of the angle between the first basis vector α₁ and the second basis vector α₂ placed tail to tail.

According to another aspect of the present disclosure, the constant filtering direction of the at least one projection of the optical filter is orientated at an angle within an angular range defined by a first angle θₘₐₓ produced by the vector addition of the first basis vector α₁ and the second basis vector α₂ and a second angle θ min defined by tan⁻¹(a1/b1) where a1 is half the magnitude of the vertical component of the second basis vector α₂ and b1 is the magnitude of the first basis vector α₁ multiplied by the total number of aperture elements along the first basis vector α₁ direction; or is orientated at said angle plus a positive or negative integer multiple of the angle between the first basis vector α₁ and the second basis vector α₂ placed tail to tail;

or the constant filtering direction of the at least one projection of the optical filter is orientated at an angle within an angular range defined by a third angle θₘₐₓ produced by the vector addition of the first basis vector α₁ and the second basis vector α₂ and a fourth angle θ1ₘᵢₙ defined by tan⁻¹(α₂/b2) where α₂ is half the magnitude of the vertical component of the first basis vector α₁ and b2 is the magnitude of the second basis vector α₂ multiplied by the total number of aperture elements along the second basis vector α₂ direction; or is orientated at said angle plus a positive or negative integer multiple of the angle between the first basis vector α₁ and the second basis vector α₂ placed tail to tail.

According to yet another aspect of the present disclosure, the angle between the first basis vector α₁ and the second basis vector α₂ placed tail to tail is substantially 60 or 90 degrees for a hexagonal or square/rectangular array respectively.

According to another aspect of the present disclosure, the first aperture array includes an array of image forming elements comprising a plurality of lenses, micro-lenses or pinholes; and wherein the first aperture array is arranged in the optical system to form a plurality of whole or integral replications of an object on a sensor plane; and wherein the filter is imaged to form at least one projection of the filter or solely one projection of the whole filter on the first aperture array to filter the plurality or each of the integral or whole object replications.

Other advantageous features are found in the other dependent claims.

The above and other objects, features and advantages of the present invention and the manner of realizing them will become more apparent, and the invention itself will best be understood from a study of the following description with reference to the attached drawings showing some preferred embodiments of the invention.

### A BRIEF DESCRIPTION OF THE SEVERAL VIEWS OF THE DRAWINGS

The above object, features and other advantages of the present invention will be best understood from the following detailed description in conjunction with the accompanying drawings, in which:

FIGS. 1a to 1f schematically show illustrations of the principle of operation of embodiments of the optical system of the present invention;

FIG. 1i shows a schematic illustration of a first or second aperture array;

FIG. 1j shows a further schematic illustration of a first or second aperture array;

FIG. 1k is a schematic illustration of a hexagonal first or second aperture array and an orientation of a constant filtering direction away from a natural filtering alignment;

FIGS. 1L and 1m are schematic illustrations of a hexagonal first or second aperture array;

FIG. 1n shows further details concerning the determination of angle θₘₐₓ and angle θₘᵢₙ;

FIG. 1g schematically shows a Super pixel configuration or arrangement similar to the Bayer configuration which is the type of images that are generated in a Plenoptics 1.0 optical system configuration;

FIG. 1h schematically shows a configuration or arrangement where a multiple series of images are generated and are each filtered;

FIG. 2 schematically shows an exemplary hyper or multi-spectral optical system according to one embodiment of the present invention;

FIG. 3 schematically shows an exemplary hyper or multi-spectral optical system according to another embodiment of the present invention;

FIGS. 4 to 6 schematically shows an exemplary hyper or multi-spectral optical system according to another embodiment of the present invention;

FIGS. 7 to 8 schematically shows an exemplary hyper or multi-spectral optical system according to another embodiment of the present invention;

FIG. 9A schematically illustrates an image sensor comprising a plurality of light sensing elements or pixels (or super-pixels) P extending in a vertical direction V and a plurality of light sensing elements or pixels P extending in a horizontal direction H, the horizontal direction H being perpendicular to the vertical direction V;

FIG. 9B schematically illustrates an exemplary optical filter including a filtering section according to the present invention;

FIG. 9C schematically illustrates an image sensor, identical to that of FIG. 9A, comprising a matrix of pixels, or alternatively an array of image forming elements such as microlenses;

FIG. 9D schematically illustrates an optical filter that is formed using a graded filter where i to ix represents positions on the filter having a different peak transmission wavelength;

FIG. 9E illustrates an image sensor or array of imaging elements comprising a N×N array of elements, and the graded filter of FIG. 9D which is aligned with the horizontal axis H of the sensor or array of imaging elements;

FIG. 9F shows one example of an optical filter including a filtering section FS according to the present invention;

FIG. 10 schematically shows the same optical system of FIGS. 4 to 6 from a perspective view showing the optical axis through the system and including the optical filter of FIG. 9B;

FIG. 11 schematically shows the same optical system of FIGS. 4 to 6 from a perspective view and including the optical filter of FIG. 9D, the filter is rotated at angle φ relative to the optical axis at the aperture and is rotated with respect to the horizontal axis of the image sensor and/or the array of imaging elements;

FIG. 12 schematically shows a linear graded filter aligned at 45° to one of the axis of the image sensor or array of imaging elements that comprise an N×N array of elements;

FIG. 13 shows system modeling in Zemax using a pair of achromatic lenses with long working distances to implement a telecentric design;

FIG. 14 shows results produced by an exemplary optical system built, based on the system modelling shown in FIG. 13, using a pair of achromatic lenses and a tilted graded filter such as that shown in FIG. 11, the filtered wavelength is assigned in the image of FIG. 14;

FIGS. 15 to 17 schematically show the inclusion of a beam-splitter in the optical system for example to increase spatial resolution; and

FIGS. 18A, 18B and 19 schematically shows an exemplary hyper or multi-spectral optical system according to another aspect of the present invention.

Herein, identical reference numerals are used, where possible, to designate identical elements that are common to the figures.

### DETAILED DESCRIPTION OF THE SEVERAL EMBODIMENTS

The optical system according to one aspect of the present disclosure includes at least one optical projection element 2, an optical filter F, a first aperture array 4 comprising a plurality of aperture elements and a second aperture array S comprising a plurality of aperture elements.

The optical filter F is configured to filter the same wavelength, intensity or polarization along a constant filtering direction CFD (or axis defined by said direction) of the filter F. For example, for a spectral filter, the same wavelength (or substantially the same wavelength) is filtered by the filter along this direction of the filter F. This spectral filter may be for example a wedge shaped filter where the direction of constant thickness (or substantially constant thickness) defines the constant filtering direction.

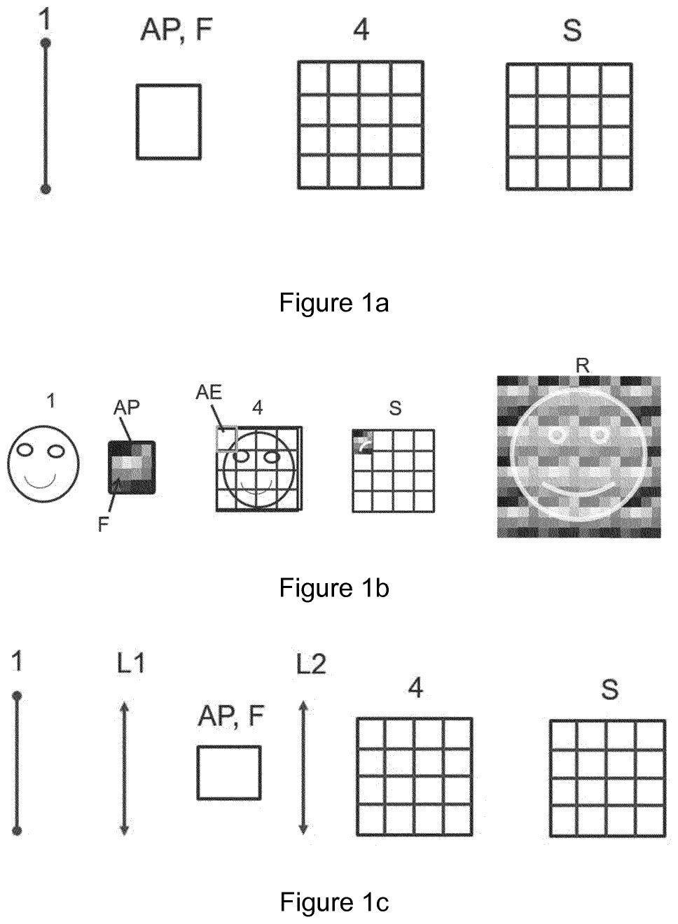

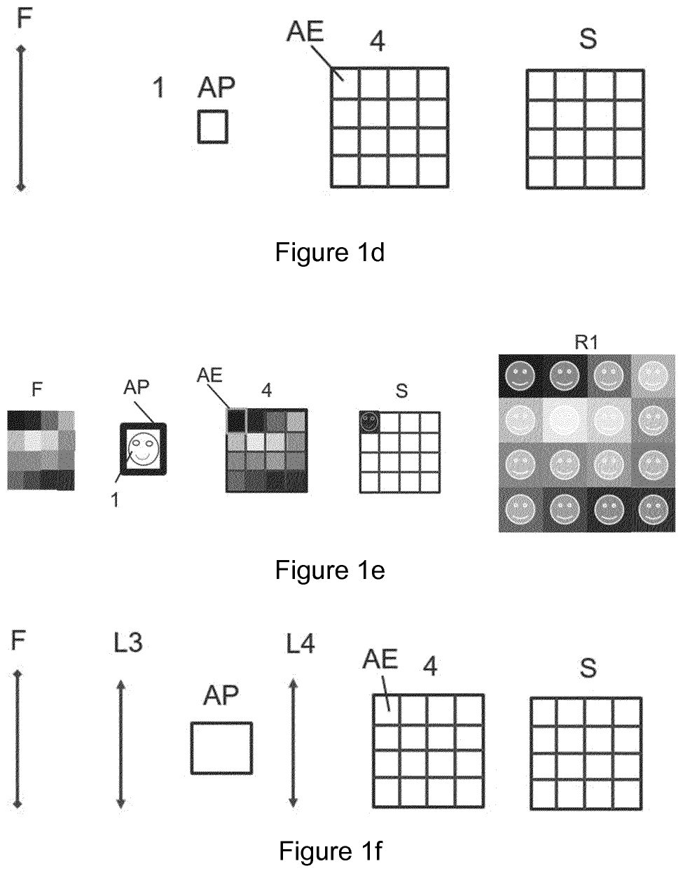

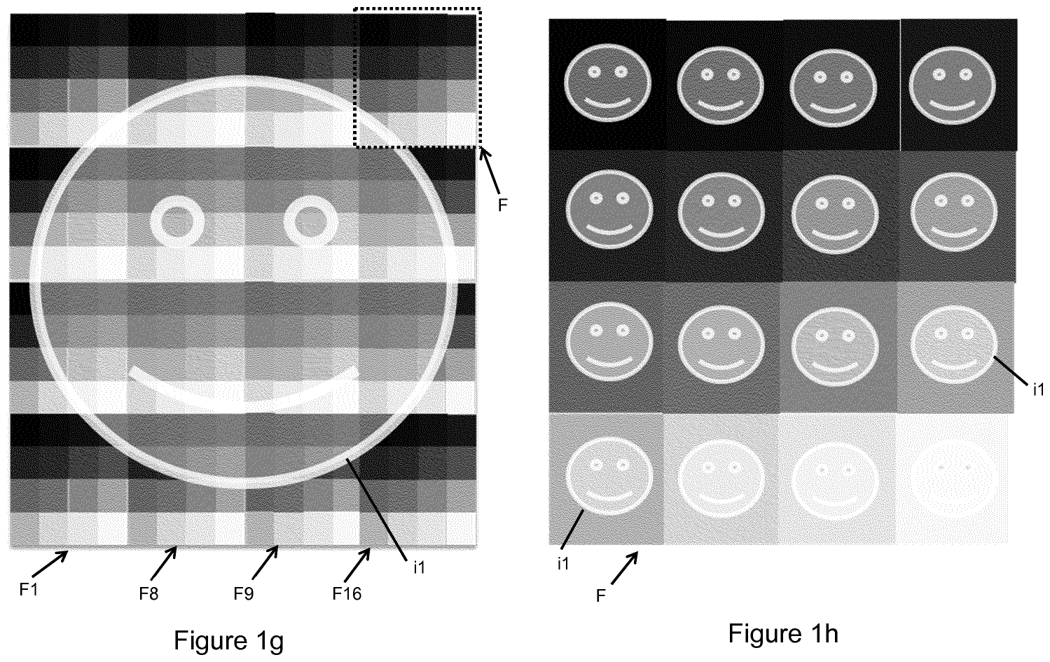

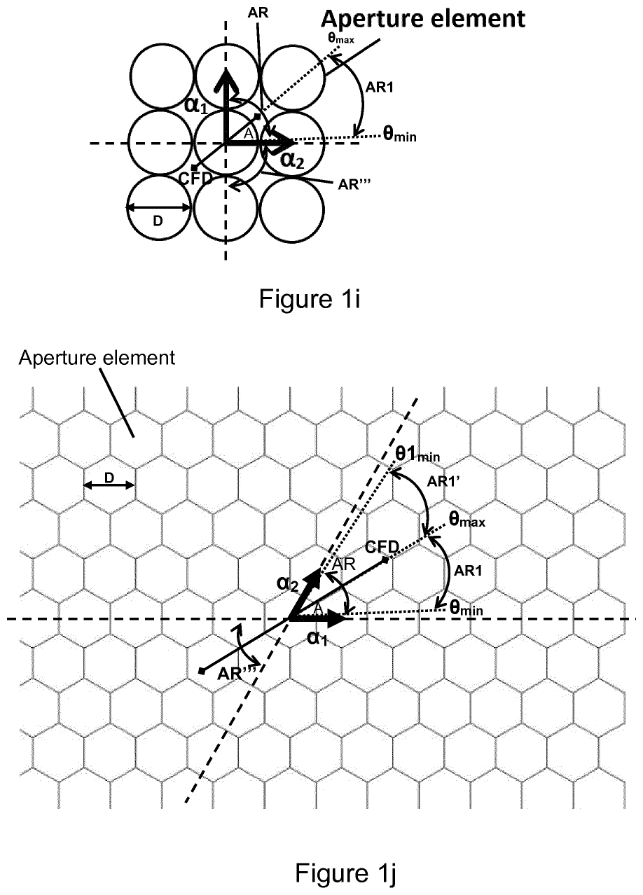

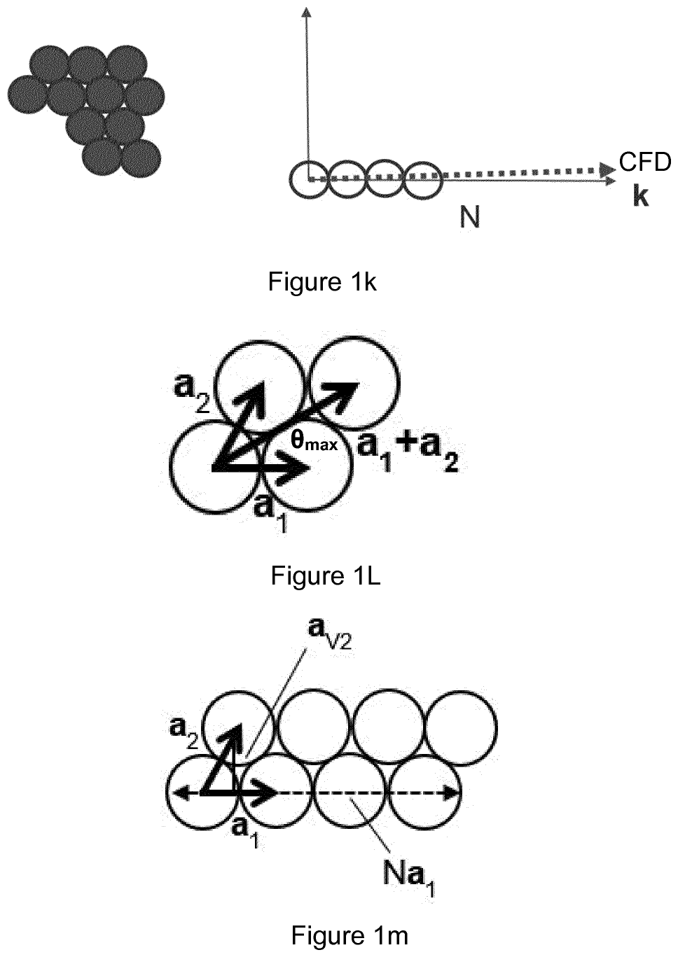

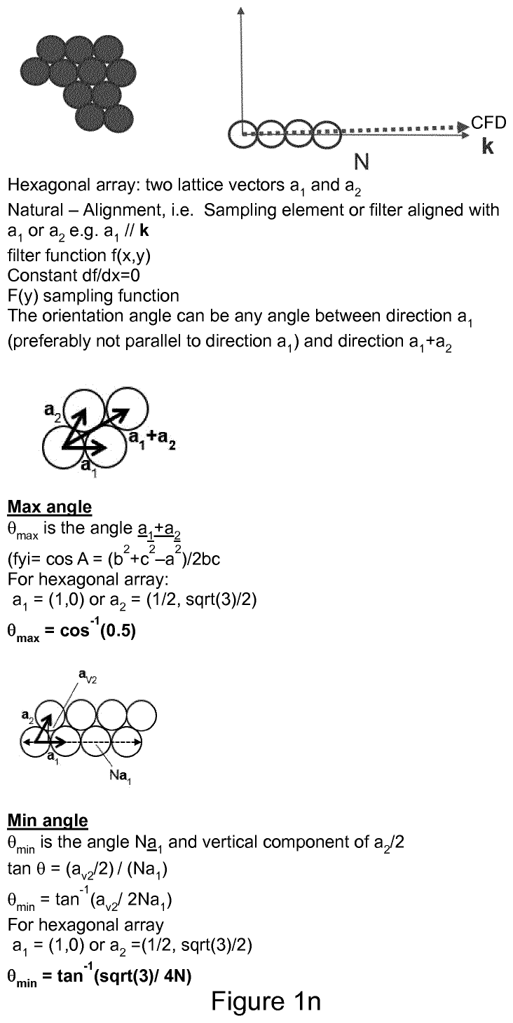

FIGS. 1a and 1b shows a schematic illustration of the principle of operation of one embodiment of the optical system permitting the configuration A (Plenoptics 1.0 configuration) such as that illustrated in FIG. 1g to be achieved.

Light rays from an object (smiley face) 1 pass through the aperture AP and the image of the object is projected onto aperture array 4. This projection is a 2D projection and can be an image projection x, y or it can be the Fourier projection theta, phi.

The filter F is, for example, placed at the aperture AP and is projected through each aperture element AE of the aperture array 4 (i.e. each aperture AE in the aperture array 4 acts as an aperture) onto the second aperture array S. This is repeated for each aperture AE resulting in a sampling as shown by reference number R, i.e. each part of the image is sampled through many filters.

The filter can be any filtering function, i.e. polarization, spectral or intensity. The filter is such that the filtering function varies in one or more directions and is constant in at least one direction (across the entire filter or solely a section of the filter), the other direction or directions being non-parallel to this constant filtering direction, for example, orthogonal.

In FIG. 1c, a first lens L1 and a second lens L2 are included. Rays from the object 1 pass through the aperture AP and are projected using the first lens L1 onto the aperture array 4.

The filter F is placed at or close to the aperture AP and is projected using the second lens L2 through each aperture element of the aperture array 4 (that is, each aperture in the aperture array 4 acts as an aperture, the aperture array can be for example a pinhole or microlens array) onto the aperture array S.

FIGS. 1d and 1e shows a schematic illustration of the principle of operation of another embodiment of the optical system permitting the configuration B such as that illustrated in FIG. 1h to be achieved.

Light rays from the filter F pass through the aperture AP and the image of the filter F is projected onto aperture array 4. The rays from a projected object 1 pass through the aperture AP and a series of images is projected onto each aperture AE of aperture array 4.

Each image on each aperture AE in the aperture array 4 passes through the filter projected onto the aperture AE. Then on aperture array S the filtered object is projected. This is repeated for each aperture AE resulting in a sampling, as indicated by reference R1, as each of the multiple images of the object 1 pass through a different aperture which corresponds to a different filter.

With reference to FIG. 1e, Rays from the filter F pass through the aperture AP and the image of the filter is projected onto aperture array 4. The projected object 1 is placed at the aperture AP and is projected through each aperture AE of the aperture array 4 (i.e. each aperture AE in the aperture array 4 acts as an aperture) onto the aperture array S. This is repeated for each aperture AE and the result is a sampling as in R1, i.e. one of each of the multiple images is passed through the filter.

In FIG. 1f, a first lens L3 and a second lens L4 are included. The filter F is placed at or projected through aperture AP onto the aperture array 4 using a lens L3. An image of the object 1 is projected onto aperture AP of the aperture array 4 (this projection is a 2D projection and can be an image projection x, y or it can be the Fourier projection theta, phi) using a lens L3, and is projected using a lens L4 through each aperture AE of the aperture array 4 (i.e. each aperture in the aperture array acts as an aperture) onto the aperture array S.

The first aperture array 4 comprises a plurality of aperture elements as schematically shown in FIG. 1i where a portion of an exemplary array 4 defining a square or rectangular matrix of aperture elements is shown. The aperture elements can be, for example, lenses, microlens or pinholes.

A location of an aperture element or each aperture element on the first aperture array 4 is defined by a first basis vector α₁ and a second basis vector α₂. The basis vectors extend in the 2D plane defined by the aperture array 4.

The basis vector magnitude defines, for example, a distance between two aperture elements, for instance, the distance from the geometrical center of one aperture element to the geometrical center of a neighboring aperture element, for example, the nearest neighbor aperture element. The basis vector magnitude may define, for example, the width or diameter of an aperture element ((see FIGS. 1i and 1j) in the plane of the array 4.

As illustrated in the exemplary embodiments of FIGS. 1i and 1j, the first basis vector α₁ extends in a first direction aligning a plurality of aperture elements and the second basis vector α₂ extends in a second different direction also aligning a plurality of aperture elements. For example, the basis vector direction aligns the geometrical center of the plurality of aperture elements. FIG. 1j shows an exemplary array defining a hexagonal matrix of aperture elements as well as the first and second basis vectors.

The first basis vector α₁ and the second basis vector α₂ are preferably set to be orthogonal in the case where the first aperture array 4 defines a square or rectangular matrix of aperture elements as shown in FIG. 1i.

In the hexagonal array 4 of FIG. 1j, the basis vectors define an angle of (substantially) 60 degrees. The basis vectors positioned tail to tail (as shown in FIGS. 1i and 1j) define an angle of 90 degrees or less.

The second aperture array S comprises a plurality of aperture elements. The second aperture array may be, for example, an image sensor S where the aperture element is a pixel or plurality of pixels or another optical element configured to capture incoming light.

A location of an aperture element or each aperture element on the second aperture array S is defined by a third basis vector β₁ and a fourth basis vector β₂. The basis vectors extend in the 2D plane defined by the aperture array S.

Similar to the first aperture array, the basis vector magnitude defines, for example, a distance between two aperture elements, for instance, the distance from the geometrical center of one aperture element to the geometrical center of a neighboring aperture element, for example, the nearest neighbor aperture element. The basis vector magnitude may define, for example, the width or diameter ((see FIGS. 1i and 1j) of an aperture element in the plane of the array S.

The exemplary embodiments of FIGS. 1i and 1j similar represent the third basis vector β₁ extending in a first direction aligning a plurality of aperture elements and the fourth basis vector β₂ extending in a second different direction also aligning a plurality of aperture elements.

The first basis vector β₁ and the second basis vector β₂ are similarly preferably set to be orthogonal in the case where the first aperture array S defines a square or rectangular matrix of aperture elements as represented in FIG. 1i.

The pair of basis vectors positioned tail to tail (as shown in FIGS. 1i and 1j) define for example an angle or angular range of 90 degrees or less.

The optical system according to one embodiment is configured to form a projection of the optical filter F on the first aperture array 4 as illustrated in FIG. 1h. The optical projection element 2, the optical filter F and the first aperture array 4 are arranged along an optical axis 8 to form a projection of the optical filter F on the first aperture array 4. The constant filtering direction of the projection of the optical filter F is orientated at an angle relative to the first basis vector α₁ direction (or an axis defined by the first basis vector α₁ direction) and is orientated relative to the second basis vector α₂ direction (or an axis defined by the second basis vector α₂ direction), as illustrated in FIGS. 1i and 1j by the dashed lines.

According to another embodiment, the optical filter can be placed in front of, behind or on the first aperture array 4 to produce the configuration of FIG. 1h. The constant filtering direction of the optical filter F is orientated at an angle relative to the first basis vector α₁ direction (or an axis defined by the first basis vector α₁ direction) and is orientated relative to the second basis vector α₂ direction (or an axis defined by the second basis vector α₂ direction).

According to one aspect of the present disclosure, the first basis vector α₁ and the second basis vector α₂ placed tail to tail define an angular range AR in between the first basis vector α₁ direction and the second basis vector α₂ direction as shown in FIGS. 1i and 1j (AR being the smaller angular range of the two possible angular ranges defined by the basis vectors).

The constant filtering direction CFD of the filter F or the filter projection is aligned to an angle contained in this angular range AR and is aligned non-parallel to the first basis vector α₁ direction and non-parallel to the second basis vector α₂ direction. The constant filtering direction CFD of the filter F or the filter projection can be aligned to any angle in the 360° range except along a direction or axis defined by the basis vectors. The constant filtering direction CFD is non-parallel to the basis vector directions or axes defined along the basis vector directions.

The angular range AR includes all angles in between the axis defined by the basis vectors but excludes an orientation of the constant filtering direction parallel to the first basis vector α₁ direction and also excludes an orientation of the constant filtering direction parallel to the second basis vector α₂ direction.

For example, the constant filtering direction CFD is, for instance, non-parallel to the optical axis 8 and rotated or orientated with respect to the plane defined by the array of apertures about the optical axis 8 or about a direction or axis parallel to the optical axis. For example, the CFD can rotate in a plane parallel or substantially parallel to the plane defined by the array of apertures.

Furthermore, the constant filtering direction of the at least one projection of the optical filter F can be orientated at the above mentioned angle A plus a positive integer multiple (1, 2, 3, 4 . . . ) or negative integer multiple (−1, −2, −3, −4 . . . ) of the angle between the first basis vector α₁ and the second basis vector α₂ placed tail to tail.

In the exemplary embodiment of FIG. 1i this angle is 90 degrees and in the exemplary embodiment of FIG. 1j this angle is 60 degrees.

FIG. 1i shows the angular range AR′″=AR+3×90° where the positive integer=3 and the angle between the first basis vector α₁ and the second basis vector α₂ placed tail to tail=90°. Consequently, if for example the angle A in the angular range AR shown in FIG. 1i is 45°, then the constant filtering direction CFD can be aligned to the angle of 45° or alternatively at 45°+1×90°=135°, or alternatively at 45°+2×90°=225° or alternatively at 45°+3×90°=315°. The same filtering or sampling improvement is obtained at each of these angles compared to an alignment parallel to one of the basis vectors.

According to another aspect of the present disclosure, the constant filtering direction of the filter projection or of the optical filter F is orientated at an angle A within an angular range AR1 (see FIGS. 1i and 1j).

The angular range AR1 is defined by a first angle θₘₐₓ and by a second angle θₘᵢₙ. The first angle θₘₐₓ is produced by the vector addition α₁+α₂ of the first basis vector α₁ and the second basis vector α₂ (as shown in FIG. 1L for a hexagonal array). The second angle θₘᵢₙ is defined by tan⁻¹(a1/b1) where a1 is half the magnitude of the vertical component α_{V2} of the second basis vector α₂ (illustrated in FIG. 1m) and b1 is the magnitude of the first basis vector α₁ multiplied by the total number N of aperture elements along the first basis vector α₁ direction (N=4 in the example of FIG. 1m). The vertical component can be defined for example as the component of the second basis vector α₂ perpendicular to the first basis vector α₁.

The angular range AR1 thus includes the angles in between the first angle θₘₐₓ and the second angle 9 min as well as the first angle θₘₐₓ and the second angle θₘᵢₙ.

The constant filtering direction is orientated at an angle A of the angular range AR1 or at this angle A plus a positive integer multiple (1, 2, 3, 4 . . . ) or negative integer multiple (−1, −2, −3, −4 . . . ) of the angle between the first basis vector α₁ and the second basis vector α₂ placed tail to tail (as explained above in relation to range AR).

An angle A that is twice the second angle θₘᵢₙ (or twice angle θₘᵢₙ plus a positive integer multiple (1, 2, 3, 4 . . . ) or negative integer multiple (−1, −2, −3, −4 . . . ) of the angle between the first basis vector α₁ and the second basis vector α₂) defines an angle at which the sampling by the filter is maximized. For, example, the angle at which the maximum number of different wavelengths can be simultaneously filtered.

The second angle θₘᵢₙ defines the angle from which a significant improvement in filtering is obtained, this improvement increasing up to the first angle θₘₐₓ. Beyond this first angle θₘₐₓ and moving angularly towards the second basis vector α₂ the improvement in filtering reduces. The maximum number of different wavelengths that can be simultaneously filtered peaks at the first angle θₘₐₓ and is symmetric around the first angle θₘₐₓ. The aperture array of FIG. 1i provides a total of four peaks at four different angles while that of FIG. 1j provides six peaks at six different angles. As the constant filtering direction is rotated from the first basis vector α₁ direction towards the second basis vector α₂, a first optimum orientation is at the first angle θₘₐₓ and continued rotation beyond the second basis vector α₂ direction will allow a further optimum orientation angle to be found. These angles for FIG. 1j are 30°, 30°+1×60°=90°, 30°+2×60°=150°, 30°+3×60°=210°, 30°+4×60°=270° and 30°+5×60°=330°.

Similarly, the constant filtering direction of the filter projection or of the optical filter F can be orientated at an angle A within an angular range AR1′ (see FIG. 1j).

The angular range AR1′ is defined by the first angle θₘₐₓ and by a second angle θ1ₘᵢₙ. The second angle θ1ₘᵢₙ is defined by tan⁻¹(a1/b1) where a1 is half the magnitude of the vertical component α_{V1} of the first basis vector α₁ and b1 is the magnitude of the second basis vector α₂ multiplied by the total number N of aperture elements along the second basis vector α₂ direction. The vertical component can be defined for example as the component of the first basis vector α₁ perpendicular to the second basis vector α₂.

The angular range AR1′ thus includes the angles in between the first angle θₘₐₓ and the second angle θ1ₘᵢₙ as well as the first angle θₘₐₓ and the second angle θ1ₘᵢₙ. The angular range AR1′ is a mirror image of the angular range AR about the first angle θₘₐₓ or the angular range AR1′ and the angular range AR are symmetric about the first angle θₘₐₓ.

The second angle θ1ₘᵢₙ is for example equal to the angle between the first basis vector α₁ and the second basis vector α₂ less the angle θₘᵢₙ.

An angle A that is equal to the angle between the first basis vector α₁ and the second basis vector α₂ less twice the second angle θₘᵢₙ (or an angle A that is equal to the angle between the first basis vector α₁ and the second basis vector α₂ less twice the second angle θₘᵢₙ plus a positive integer multiple (1, 2, 3, 4 . . . ) or negative integer multiple (−1, −2, −3, −4 . . . ) of the angle between the first basis vector α₁ and the second basis vector α₂) defines a further angle at which the sampling by the filter is maximized.

The constant filtering direction is orientated at an angle A of the angular range AR1′ or at this angle A plus a positive integer multiple (1, 2, 3, 4 . . . ) or negative integer multiple (−1, −2, −3, −4 . . . ) of the angle between the first basis vector α₁ and the second basis vector α₂ placed tail to tail (as explained above).

FIG. 1n shows further details concerning the determination of angle θₘₐₓ and angle θₘᵢₙ

According to yet another embodiment, the optical system is configured to form a multiple projections of the optical filter F on the second aperture array S as illustrated in FIG. 1g where one projection is shown surrounded by a dotted frame at the top right of FIG. 1g. The optical projection element 2, the optical filter F, the first aperture array 4 and the second aperture array S are arranged along the optical axis 8 to form multiple projections of the optical filter on the second aperture array S. The constant filtering direction of one projection (or sub-projection) of the optical filter F (shown surrounded by a dotted frame at the top right of FIG. 1g) is orientated at an angle relative to an axis defined by the third basis vector β₁ direction and relative to an axis defined by the fourth basis vector β₂ direction. The constant filtering direction CFD is orientated with respect to the plane defined by the aperture elements of the first or second aperture array.

The constant filtering direction CFD can be orientated with respect to the second aperture array S at the same angle A and at an angle in the above mentioned angular ranges as defined above with respect to the first aperture array 4. For the sake of conciseness, the above description given with respect to the angle A and the first aperture array 4 is not repeated here but applies identically to the relation between the orientation of the constant filtering direction CFD and the second aperture array S described using the basis vector β₁ and the basis vector β₂.

Alternatively, the constant filtering direction of the projection of the optical filter F or of the filter F can be orientated at an angle A within the possible angular ranges each defined by (i) the angle θₘₐₓ and (ii) the angle θₘᵢₙ+Y degree(s) where Y=a positive integer (1, 2, 3, 4 . . . ) or by (i) the angle θₘₐₓ and (ii) the angle θ1ₘᵢₙ−Y degree(s) where Y=a positive integer (1, 2, 3, 4 . . . ), or is orientated at said angle A plus a positive or negative integer multiple of the angle between the first basis vector α₁ and the second basis vector α₂ placed tail to tail or plus a positive or negative integer multiple of the angle between the third basis vector (β₁) and the fourth basis vector (β₂) placed tail to tail (as explained previously).

The angular range can thus be for example that defined by (i) the angle θₘₐₓ and (ii) the angle θₘᵢₙ+1 degree or by (i) the angle θₘₐₓ and (ii) the angle θₘᵢₙ+2 degrees etc. Similarly, the angular range can thus be for example that defined by (i) the angle θₘₐₓ and (ii) the angle θ1ₘᵢₙ−1 degree or by (i) the angle θₘₐₓ and (ii) the angle θ1ₘᵢₙ−2 degrees etc.

As mentioned previously, the optical filter F is configured to filter the same wavelength, intensity or polarization along a constant filtering direction CFD of the filter F. The filter includes at least one constant filtering direction. The constant filtering direction may fully extend across the entire filter or extend across only a portion of the filter. The optical filter F is configured to filter the same or substantially the same wavelength, intensity or polarization along a constant filtering direction CFD of the filter F.

For example, filtering varies (for instance continuously) along one or more directions (across the entire or solely a portion of the filter) non-parallel to the constant filtering direction.

The optical filter F is configured to filter the same or substantially the same wavelength, intensity or polarization over the width or diameter D (see for example FIGS. 1i and 1j) of at least one aperture element of the first or second aperture array.

In one embodiment, the optical projection element 2 is an objective lens 2, the second aperture array S is an image sensor S comprising a plurality of light sensing elements and the first aperture array 4 is an array 4 of image forming elements comprising a plurality of image forming elements. The optical system includes the at least one objective lens 2, the optical filter F, the array 4 of image forming elements, and the image sensor or detector S.

The optical filter F is positioned away from the image sensor S. The advantages of using a filter located away from the detector were previously outlined above.

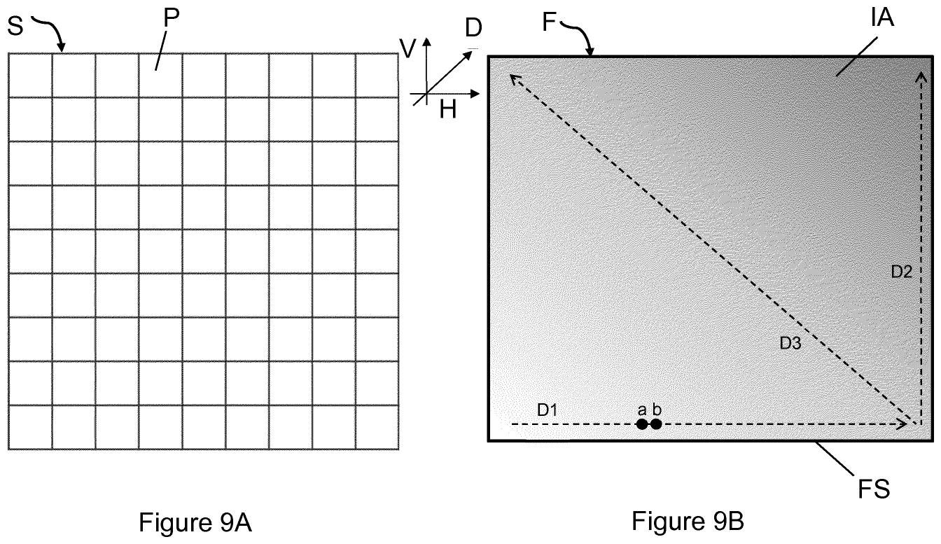

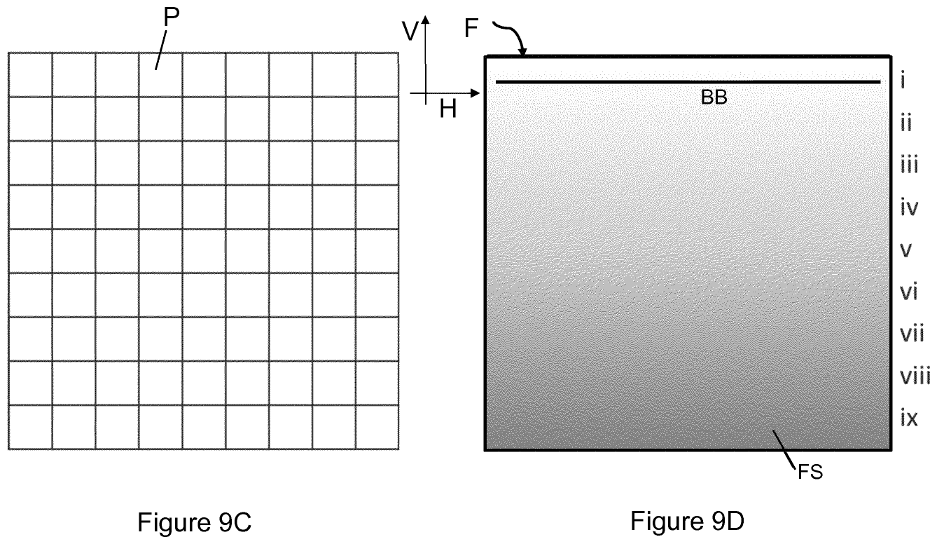

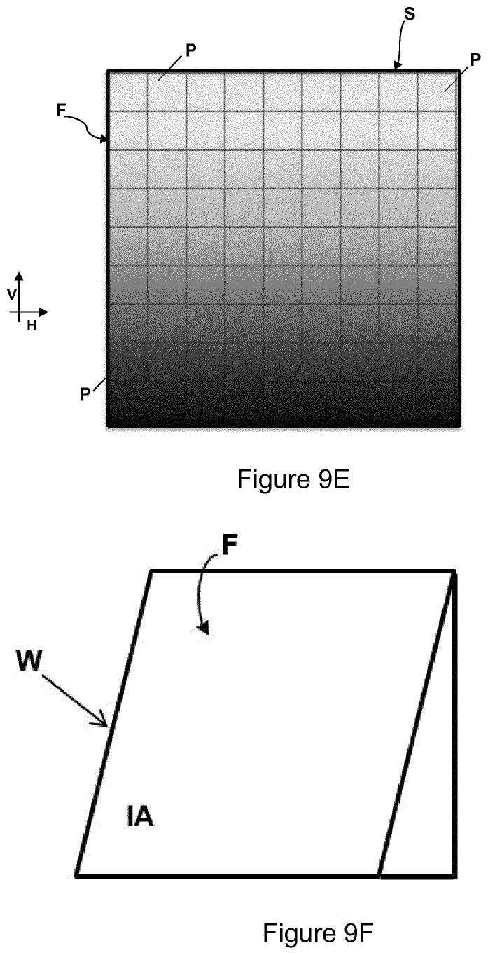

The image sensor S (see for example FIG. 9A) can define a plane and comprise a plurality of light sensing elements or pixels (or super-pixels) P extending in a vertical direction V and a plurality of light sensing elements or pixels P extending in a horizontal direction H, the horizontal direction H being perpendicular to the vertical direction V. The image sensor S is thus a 2D detector array.

Alternatively, the image sensor S comprises a plurality of light sensing elements or pixels (or superpixels) P extending only in the vertical direction V or a plurality of light sensing elements or pixels P extending only in a horizontal direction H thus forming a 1D detector array.

The image sensor S is, for example, a CMOS device comprising a plurality of pixels each configured to individually capture incoming light or an active pixel sensor (APS) containing an array of pixel sensors each comprising for example a photodetector and amplifier.

The image forming elements of the array 4 contain, for example, a plurality of lenses, micro-lens or pinholes. The array 4 of image forming elements preferably contains a plurality of image forming elements extending in the vertical direction V and a plurality of image forming elements extending in the horizontal direction H when the image sensor S is a 2D array. The array 4 may for example have a layout identical to that of the pixels (or super-pixels) P of the image sensor S as shown in FIG. 9A or 9C where P in such a case represent an imaging element such as a micro-lens or pinhole.

Alternatively, the array 4 of image forming elements contains a plurality of image forming elements extending in the vertical direction V or a plurality of image forming elements extending in the horizontal direction H when the image sensor S is a 1D array.

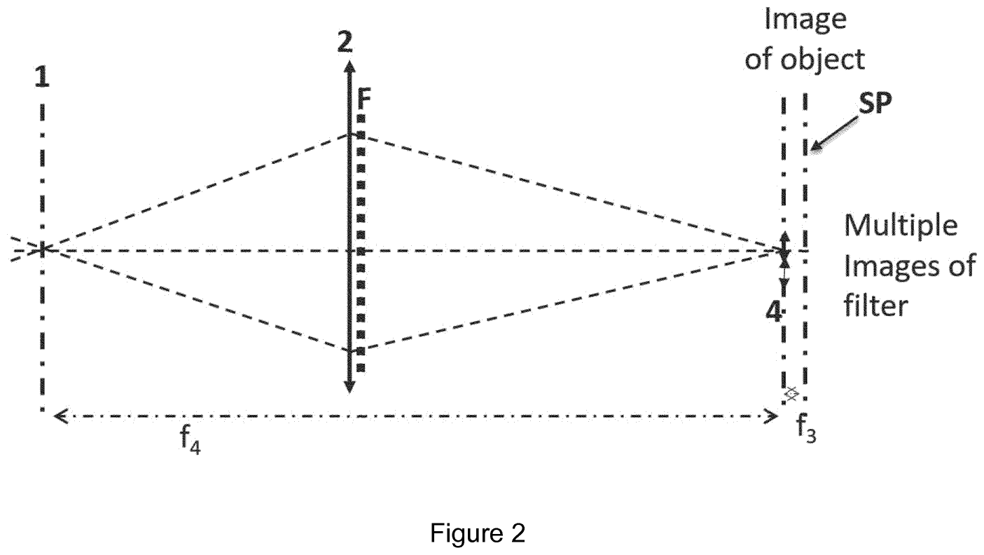

The objective lens 2, the optical filter F, the array 4 of image forming elements and the image sensor S are arranged along an optical axis 8 so that each element of the array 4 forms an image of the optical filter F on the image sensor S (or at a sensor plane SP) and the lens 2 forms an image i1 of an object 1 on the image sensor S (or at a sensor plane SP). One exemplary embodiment of such a set-up is shown in FIG. 2.

Rays from the same position in object 1 space (equally dashed lines) form an image on the array 4.

Each image forming element of the array 4 samples a certain part of the object space. The system can be built such that there is no overlap. Namely, the same part of the object is never seen by more than one element of the array 4. The filter F is imaged by each element of array 4 on the sensor plane SP.

As shown in FIG. 2, the filter F is in contact with the lens 2 or closely in front of the objective lens 2, and f₄ is the distance of the object 1 from the array 4.

This permits the configuration A such as that illustrated in FIG. 1g to be achieved.

In the exemplary illustration of FIG. 1g, a total of 16 reproductions F1 . . . F16 of filter F is produced by an array 4 containing at least 16 elements (microlens) are shown. The filter F filters for example 4×4 different wavelengths schematically represented by 16 tiles in the dotted frame in the top right of FIG. 1g. Thus, each of 16 reproductions F1 . . . F16 filters these same wavelengths. The image i1 of object 1 is also shown. The 16 reproductions F1 . . . F16 of filter F is repeated in a pixel like manner so that each of the reproductions F1 . . . F16 filter different parts of the imaged object i1 at the same filtering wavelengths. The filter F is represented schematically in FIG. 1g for ease of understanding and further details of filter F are provided below.

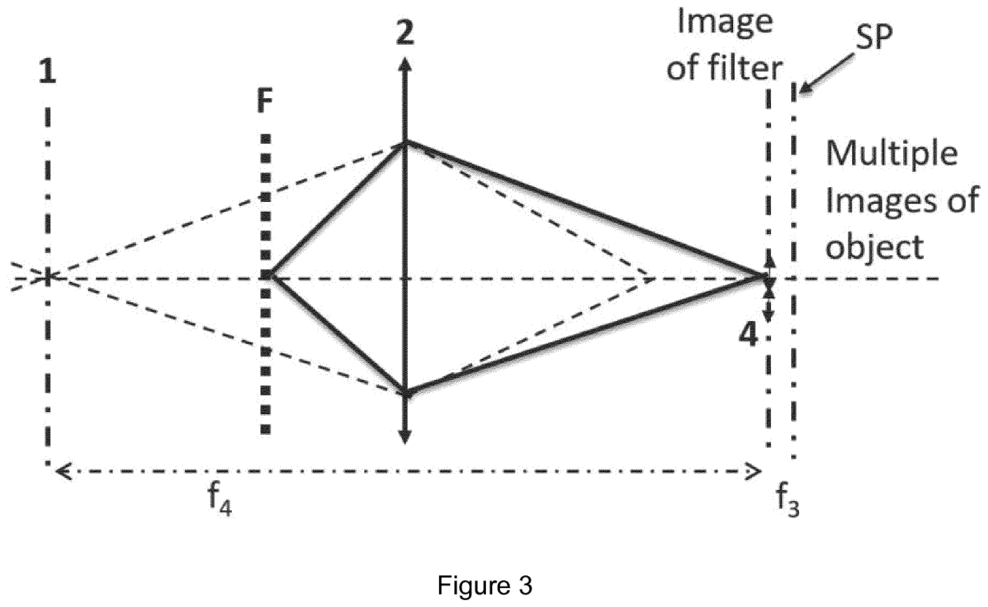

According to another embodiment, the objective lens 2, the optical filter F, the array 4 of image forming elements and the image sensor S are arranged along the optical axis 8 so that the array 4 forms multiple images i1 (FIG. 1h) of the object on the image sensor S (or at the sensor plane SP), and the objective lens 2, the optical filter F, the array 4 of image forming elements and the image sensor S are arranged along the optical axis 8 to form an image of the filter F on or across the image forming elements of array 4. One exemplary embodiment of such a set-up is shown in FIG. 3. The system is thus configured to form a real image of the filter on the array 4 of image forming elements to filter the multiple images i1 of the object 1.

The optical filter F can be (physically or materially) located at a position upstream (behind) from the objective lens 2 (as shown in FIG. 3 or can be in contact with the objective lens 2 so that the filter F is imaged by the objective 2 onto the array 4 of image forming elements (a real image of the filter is formed on the array 4). The object 1 is also located at a position upstream (behind) from the objective lens 2.

As shown in FIG. 3, the filter F is (physically) located in object space behind (upstream relative to the light incident direction) the lens 2. f₄ is the distance of the object 1 from the array 4 and f₃ is the focal distance of the elements of the array 4.

Rays from the same position in object 1 space (equally dashed lines) form an image before the array 4 via lens 2 (behind (upstream relative to the light incident direction) the array 4). Each element of the array 4 images the object 1 onto the sensor plane SP thus forming multiple images of the object at the sensor plane. The filter F is imaged by the same lens 2 onto the elements of the array 4 forming a real image of the filter on the array 4.

The multiple images i1 can thus be filtered for example at different wavelengths given that the filter F has been imaged onto the imaging forming elements.

This permits the configuration B such as that illustrated in FIG. 1h to be achieved.

In the exemplary illustration of FIG. 1h, a total of 16 reproductions of image i1 of the object 1 produced by an array 4 containing at least 16 elements (microlens) are shown. The filter F filters for example 4×4 different wavelengths schematically represented by 16 tiles. The 16 reproductions of image i1 is repeated in a pixel like manner so that each of the reproductions of the imaged object i1 is for example filtered at different filtering wavelengths. The filter F is represented schematically in FIG. 1h as tiles for ease of understanding and further details of filter F are provided below.

Alternatively, the optical filter F is placed along the optical axis 8 in front of (downstream), behind (upstream) or on the array 4 of image forming elements (not illustrated). In other words, the filter F is physically positioned in front of, behind or on the array 4 and not located behind lens 2 as shown in FIG. 3. This equally permits configuration B of FIG. 1h to be achieved. For optimal results, it is preferably to position the optical filter F as close to the array 4 as possible but this is not necessary.

The optical filter F of the optical system of all embodiments of the present inventions can include a filtering section FS as illustrated for example in FIG. 9B or 9D. The optical filter F can comprise only filtering section FS or may include filtering section FS (at least one) as well as other filters different or identical to filtering section FS.

The optical filter F can be, for example, configured to filter wavelengths in the visible or infra-red spectrum.

The filter F can be a spectral filter in the visible or infra-red spectrum, but alternatively a polarization filter or an intensity filter or any combination of these. The filter can thus be configured to simultaneously filter spectrally and in polarization.

The filter F can alternatively be an intensity filter or a polarization filter. The filter F could also be any combination of such filters.

An exemplary intensity filter is a neutral density filter but the present invention is not limited to such an intensity filter and generally concerns any intensity filter that modifies the light intensity which is for example modified identically or differently spatially across the filter, and/or modified identically or differently spectrally across the filter. Nevertheless, this filter contains at least one constant filtering direction CFD across which the light intensity filtering is constant or substantially constant.

An exemplary polarization filter is a waveplate or retarder but the present invention is not limited to such a polarization filter and generally concerns any polarization filter that modifies the light polarization direction which is for example modified identically or differently spatially across the filter, and/or modified identically or differently spectrally across the filter. Nevertheless, this filter contains at least one constant filtering direction CFD across which the polarization filtering is constant or substantially constant.

The optical filter F and filtering section FS define an incident surface area IA for receiving light to be filtered. The filtering section (FS) includes the constant filtering direction CFD that extends entirely or partially across the filtering section FS.

According to one embodiment, the filtering section FS is for example configured to continuously filter light across the incident surface area IA. The filtering section FS always filters light across the incident surface area IA.

That is, filtering occurs at each position on the incident surface area IA. There is no interruption in filtering at any position on the incident surface area IA. The filtering section FS does not contain borders or interruptions that interrupts the light filtering that are present for example in known mosaic construction filters.

In other words, if the filtering section FS is for example configured to filter in the visible spectrum and a collimated beam of white light producing a small spot size on the filter section FS was displaced across the incident surface area IA, then the incident white light would always undergo filtering by the filter section FS as the spot is displaced across the incident surface area IA.

The filtering section FS is configured to continuously filter light that is incident on and across the incident surface area IA along a direction D1 of the incident surface area IA as shown in FIG. 9B.

The direction D1, for example, extends in or is parallel to the horizontal direction H in which the elements p of the image sensor S extend, as shown in FIG. 9A.

The filtering section FS is configured to filter at the same wavelength or substantially the same wavelength) across the incident surface area IA along the direction D1 following the horizontal direction H.

That is, the filtering section FS is configured to continuously filter across the incident surface area IA along a horizontal direction H, and configured to continuously filter at the same wavelength across the incident surface area IA along the horizontal direction H, the horizontal direction H being defined as above or alternatively defined as being the direction perpendicular to the optical axis 8 and to the earth's gravitational force direction g acting on the filter F.

The spectral filtering can be constant in wavelength across the direction D1 of the filter section FS, or can be constant only at one distinct portion along the direction D1 or can be constant at a plurality of different portions of the filter section along the direction D1 (or can be any combination of these). The constant spectral filtering of wavelength can occur between positions a and b in FIG. 9B which can be a few nanometers or tens of nanometers or more.

The filtering section FS can be further configured to continuously filter light that is incident on and across the incident surface area IA along directions D2 and/or D3 of the incident surface area IA as shown in FIG. 9B. The direction D2 extends in or is parallel to the vertical direction V in which the elements p of the image sensor S extend, as shown in FIG. 9A. The direction D3 extends in the diagonal direction at 45° to directions D1 and D2.

The filtering section FS is configured to filter at different wavelengths along the direction D2 following the vertical direction V and along the diagonal direction D3. The spectral filtering can be continuously varying in wavelength across the directions D2 and/or D3 of the filter section FS, or can vary only at one distinct portion along the directions D2 and/or D3 or can vary only at a plurality of different portions of the filter section along the directions D2 and/or D3 (or can be any combination of these). The change in spectral filtering wavelength can be gradual or abrupt.

It is noted that the direction D1 is not limited to the specific direction D1 illustrated in FIG. 9B but is to be understood as any direction parallel to the illustrated direction D1 along the filter section FS. This is equally true for directions D2 and D3.

In another embodiment, the filtering section FS can be configured to continuously filter light, that is incident on and across the incident surface area IA, along all directions of the incident surface area IA that are non-parallel to the constant filtering direction of the filter F. The filtering section FS is configured to filter at different wavelengths along all non-parallel directions across the incident surface area.

Spectral filtering can be continuously varying in wavelength across all non-parallel directions of the filter section FS, or can vary only at one distinct portion along one non-parallel direction or can vary only at a plurality of different portions of the filter section along a plurality of non-parallel directions (or can be any combination of these). The change in spectral filtering wavelength can also be gradual or abrupt.

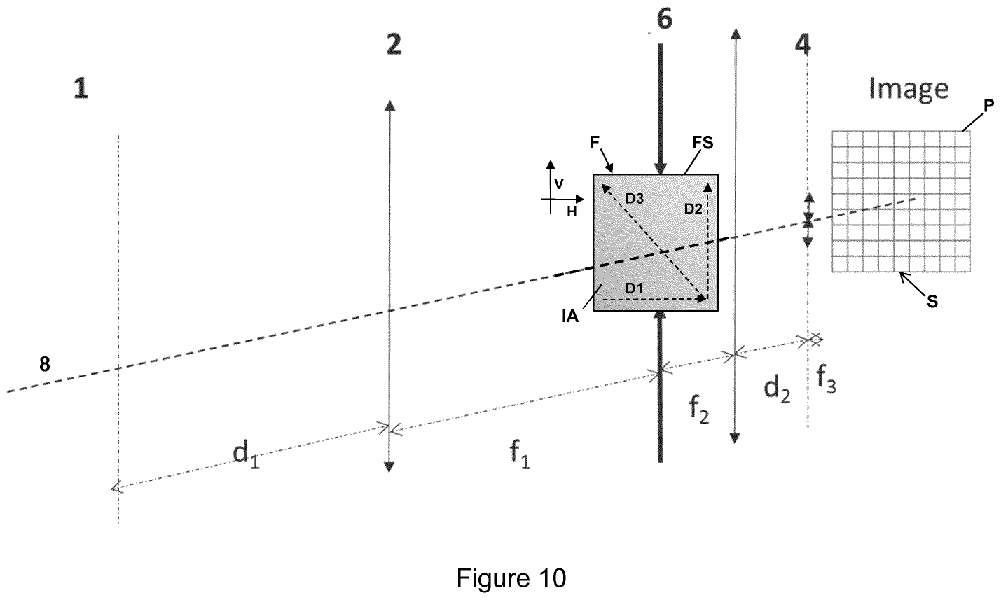

FIG. 10 shows an exemplary optical system including a filter F containing such a filtering section FS.

The filtering section FS can for example comprise one layer of optical material or a plurality of superposed optical layers. The layer (or layers) is a continuous layer defining the incident surface area IA.

The optical thickness of the filtering section can vary across the entire filtering section FS along the directions D2, D3 but is constant along the direction D1. Alternatively, the optical thickness of the filtering section can vary across only a portion or a plurality of different portions of the filtering section along the directions D2, D3 or along all directions. The optical thickness of the filtering section FS can vary across the filter continuously in a linear or non-linear manner, and/or vary according to a step-profile. This permits a large range of spectral filters to be constructed in which different wavelengths or the same wavelengths can be filtered at different spatial position along or across the filter directions D2 and/or D3.

The manufacturing of such a filter is advantageously less complex and cheaper and permits a hyper or multi-spectral optical system that is less complex and less expensive to be produced while still allowing filtering at multiple wavelengths and allowing the range of angles impinging on the filter to be small permitting accurate filtering.

Another embodiment relates to a linear graded filter as schematically shown for example in FIG. 9D. The manufacturing of such a filter is advantageously less complex and cheaper.

In such a linear filter the filtered wavelength varies continuously with position in the vertical direction V. The wavelength filtered by the linear graded filter is constant along one axis, that is, along direction H. This is schematically shown in FIG. 9D by a line BB and corresponds to the constant filtering direction CFD. The same wavelength (or substantially the same wavelength) is filtered in a direction across line BB. A different wavelength is filtered as one moves down the filter from i to ix. A line BB at each of the different positions i to ix filters the same wavelength in a direction across that line. In this example, only 9 different wavelengths i to ix can be filtered.

The number of usable wavelengths when this filter is used in a naturally aligned manner in a hyperspectral/mulitspectral system is generally limited.

FIG. 9E shows an exemplary 9×9 array (N×N array where N=9) of parallel images i1 or 9×9 pixels or super-pixels P on the image sensor S. The linear graded filter F will reduce the potential number of filtered wavelengths to just 9, or in the generic case it reduces the range from N² to N. This is clearly illustrated in FIG. 9E, where the filter F is aligned on top of the detector S. From FIG. 9E, it can be understood that only 9 different wavelengths are filtered.

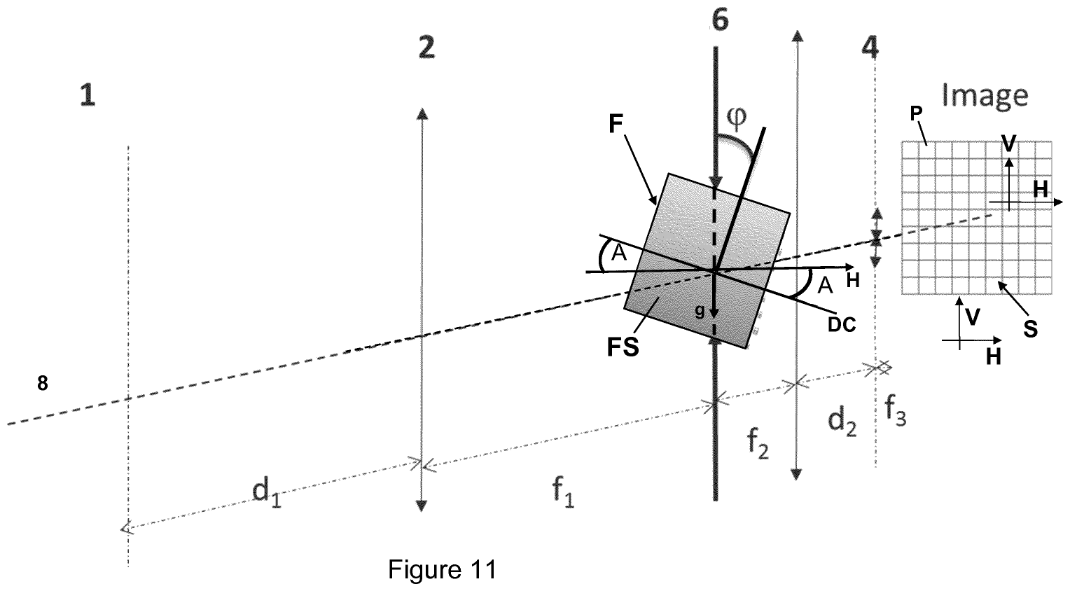

According to one aspect of the present disclosure, the multispectral or hyperspectral system includes such a filter F tilted around the optical axis 8 of the optical system to change the alignment between the constant filtering direction CFD of the filter F and either the matrix of pixels P of the image sensor S or the array 4 of imaging elements as illustrated for example in FIG. 11. The preferred orientation angle A of the constant filtering direction CFD of the filter F with respect to the sensor S has been disclosed earlier in association with, for example, FIGS. 1i and 1j.

The CFD is rotated or orientated about the optical axis 8 (or about a direction or axis parallel to the optical axis). The CFD is rotated with respect to the plane defined by the array.

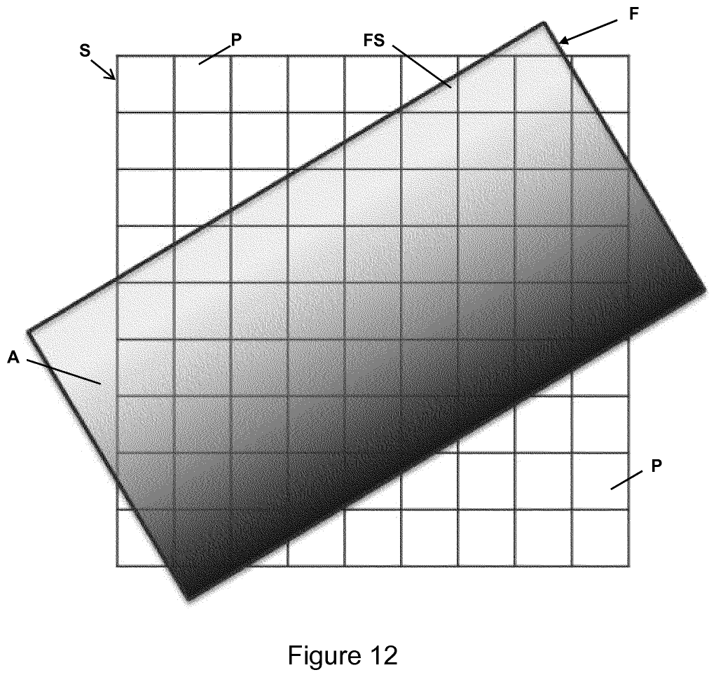

When tilted at an angle of 45 degrees as illustrated in FIG. 12, assuming a square matrix N×N, the number of different filtered wavelengths becomes 2N−1. For the 9×9 array, a total of 17 different wavelength filters is possible. It is preferable that the filter F of FIG. 12 has a surface area A that covers all diagonal rows of the image sensor S.

If the filter is tilted at an angle tan⁻¹(1/C), then all C² possible wavelength filters can be used where C is the number of images i1 (or imagelets generating imaging elements of array 4 i.e. 16 in FIG. 1h) in an optical system arranged to produce configuration B of FIG. 1hb, or C is the number of pixels of the image sensor S behind each imaging elements of array 4 in an optical system arranged to produce configuration A of FIG. 1a.

The extension to a rectangular configuration N×M (where NOM) is identical. The angle tan⁻¹(1/C) is the angle that gives maximum number of distinct central wavelengths for a linear graded filter.

It is to be noted that by wavelength it is meant central wavelength as the filtered wavelength may have a linewidth and thus other wavelengths around a central wavelength may be filtered but to a reduced extent to that of the central wavelength.

As illustrated in the exemplary optical system of FIG. 11, the filtering section FS and filter F is orientated at an angle A about the optical axis 8 and orientated with respect to the image sensor S. The axis DC of constant optical thickness (corresponding to the constant filtering direction) of the filtering section FS is orientated at an angle A relative to the horizontal direction H or the horizontal axis of the image sensor S in which a plurality of light sensing elements or pixels/super-pixels P extend in the horizontal direction H or alternatively at an angle A to the direction H perpendicular to the optical axis 8 and to the earth's gravitational force direction g acting on the filter F.

The angle A can be varied to determine and maximize the number of filtered wavelengths as explained previously.

While FIG. 11 shows one particular optical setup, it is to be understood that this tilted filter whether it be a spectral filter as described above, or an intensity filter or a polarization filter can be used in any optical system configured to implement configurations A or B of FIG. 1g or 1h.

The filter section FS can be for example either linearly graded in the form for example of a Fabry-Perot Wedge W (such as shown in FIG. 9F) or can be also be a matrix or assembly of discrete filters. For example, the optical thickness of the filtering section FS can vary across the filter according to a step-profile to produce such an assembly of discrete filters.

An exemplary linear graded filter is the Linear Variable Bandpass Filter for Hyperspectral Imaging (LF103252) from Delta Optical Thin Film. This has for example a 25 mm×25 mm area size, with wavelength filtering in the range of 450 nm to 850 nm. The spectral width of a typical filtering peak of FWHM of 4% of the linewidth and with an out of band rejection being <0.01%. The filtering section FS can, as previously mentioned, be linearly or non-linearly graded.

The filter F can be for example formed from thin film coatings on glass substrates that can be patterned during deposition (in situ), or by using a photolithographic process over the coating to block the addition or subtraction of materials deposited on the substrate surface, e.g. Materion.

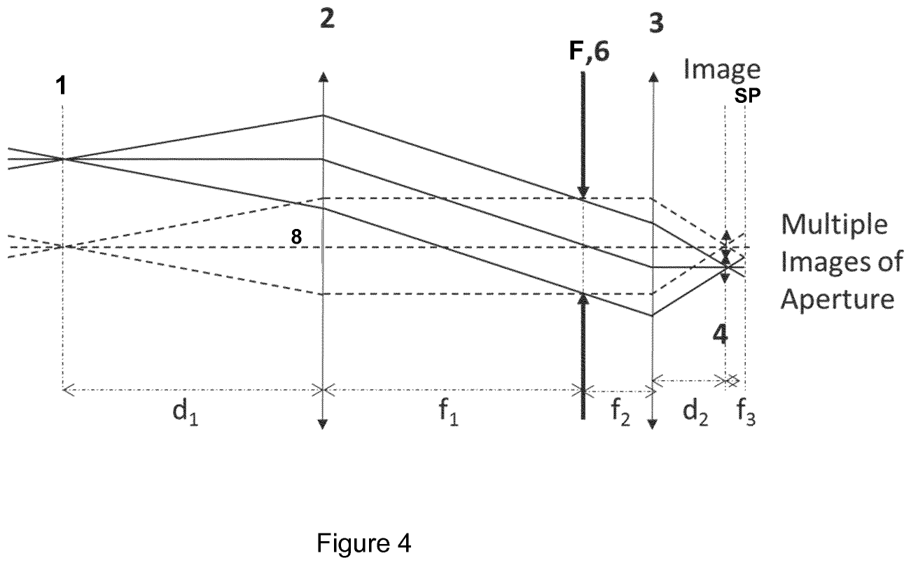

FIGS. 4 to 8 illustrate further exemplary embodiments of optical systems of the present disclosure.

FIGS. 4 to 6 show an exemplary optical system configured to implement configuration A of FIG. 1g. The system comprises the objective lens 2, an imaging lens 3, an aperture stop 6 positioned between the objective lens 2 and the imaging lens 3, as well as the array 4 of image forming elements positioned between the imaging lens 3 and the image sensor S.

All elements are arranged along the optical axis 8. The image sensor S is not shown in FIGS. 4 to 6 for clarity reasons but is represented by the sensor plane SP.

The lens 2 has a focal distance f₁, the lens 3 has a focal distance f₂ while the imaging forming elements of array 4 have a focal distance f₃. d₁ is the object distance from objective lens 2 and d₂ is the image distance where

$${d}_{2} = \frac{{f}_{2}}{{f}_{1}} ( {f}_{1} + {f}_{2} - \frac{{f}_{2}}{{f}_{1}} {d}_{1} )$$

and d₁ can range from 0 to

$$\frac{{f}_{2}}{{f}_{1}} ( {f}_{1} + {f}_{2} )$$

while d₂ ranges from

$$\frac{{f}_{2}}{{f}_{1}} ( {f}_{1} + {f}_{2} ) to 0.$$

The optical filter F is preferably located at or in the aperture stop 6 or in front of (downstream relative to the light incident direction) or behind (upstream relative to the light incident direction) the aperture stop 6 or (substantially) at the focal points f₁ and f₂ or in front of (downstream) or behind (upstream) the focal points f₁ and f₂ so that an object 1 is imaged using the objective lens 2 and the second lens 3 onto the array 4 of image forming elements.

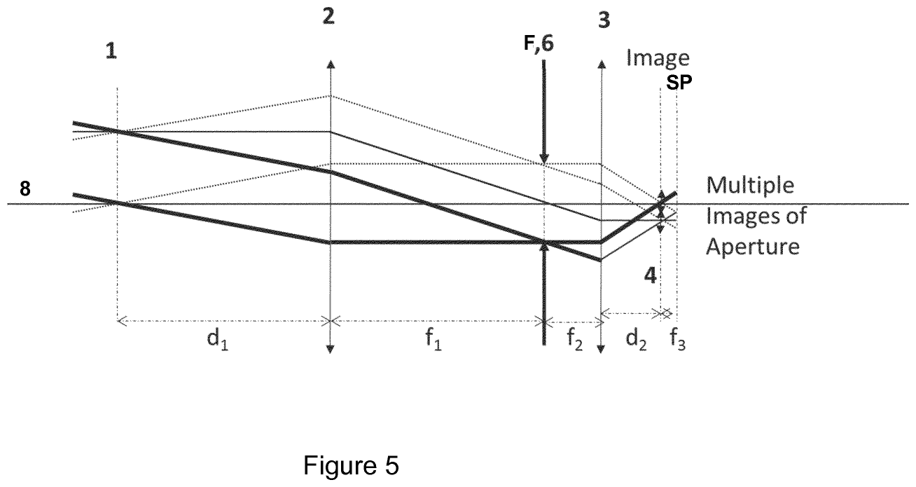

The array 4 of image forming elements is shown in the exemplary systems of FIGS. 4 and 5 located at the distance d₂ from the imaging lens 3 and at a distance f₃ from the sensor plane SP (sensor S). However, it is noted that this is not necessary for the system to function and the array 4 of image forming elements can be located about the distance d₂ from the imaging lens 3 and about the distance f₃ from the sensor plane SP (sensor S).

It is not necessary that the system of FIGS. 4 to 6 includes the aperture stop 6. In such a case the optical filter F and filtering section FS are located at or in front of (downstream) or behind (upstream) the focal point f₁ of the objective lens 2. The optical filter F is preferably also located at or in front of (downstream) or behind (upstream) the focal point f₂ of the lens 3.

The array 4 of image forming elements images the aperture stop 6 and/or filter F onto the image sensor S (sensor plane SP) to provide a plurality of images of the optical filter F and the filtering section FS at the image sensor S (sensor plane SP).

The aperture stop 6 is located (substantially) at or about the focal point f₁ of the objective lens 2 to control a distribution of light rays over a surface of the array 4 of image forming elements to control the perspective of the imaged object 1 allowing telecentric operation (telecentric in object space). The aperture stop 6 is also located behind the second lens 3 substantially at or about the focal point f₂ of the second lens 3 (telecentric in image space) to create a doubly telecentric system limiting light rays from the object 1.

The filter F is reimaged behind the array 4 to recreate configuration A (FIG. 1g). As previously mentioned, this is known as the Levoy-Hostmeyer configuration or Plenoptics 1.0 configuration in terms of light field imaging. The goal of the system is to produce a super-pixel configuration as schematically shown in FIG. 1g. As schematically shown in FIGS. 4 and 5, each part of an object 1 is imaged using lens 2 and lens 3 onto part of the array 4.

The array 4 images the aperture 6 and/or filter F onto the image sensor S. The filter F at the aperture stop 6 allows an identical array of images of the filter F to be made on the image sensor S. The aperture stop 6 limits the cross sectional area of the bundle of rays from the object 1 to the image point. Here the aperture stop 6 at the focal point of the lens 2 controls the distribution of rays over the surface of the elements of the array 4 for the purpose of controlling the perspective of the object 1 allowing a telecentric scheme.

FIG. 4 schematically shows a Plenoptics 1.0 configuration or Levoy-Hostmeyer configuration used for hyperspectral imaging. The filter F is for example placed at the aperture 6. Rays from the same position in object space fill completely the aperture 6 and are imaged onto the array 4. Each element of array 4 samples a certain part of the object space. There is no overlap. The same part of the object is preferably never seen by more than one element of array 4.

FIG. 5 schematically shows rays with the same angle in object space (e.g. bold lines) passing through the same point on the filter F or aperture 6 and each come to a focus with the same relative position behind the array 4. The image of the aperture 6 or filter F is made by lens 3. The array 4 makes an array of identical imagelets of the aperture plane and/or filter F.

As schematically shown in FIG. 4, the system is made doubly telecentric (meaning the system is telecentric in both the object space and telecentric in the image space) by placing a small aperture stop 6 (an aperture stop limiting the rays incident on the array 4 to those that are substantially parallel to the optical axis 8) at the focal distance of the first lens 2 i.e. f₁ upstream of the object lens 2 and at the focal distance of the lens 3, i.e. f₂ downstream of the image lens 3, to limit the rays from object points of the object 1. The light goes through only a small (central) portion of the lens 3. As the filter F and/or aperture stop 6 are at the focal points of the first 2 and second 3 lenses (f₁ & f₂) the central ray of each bundle is parallel to the lens axis. If the object is moved nearer or further from the lens 2, this bundle still has its central ray parallel to the lens axis, and that ray reaches the same point of the image plane as it does for other positions of the object. Thus, the magnification of the image is constant with respect to object position.

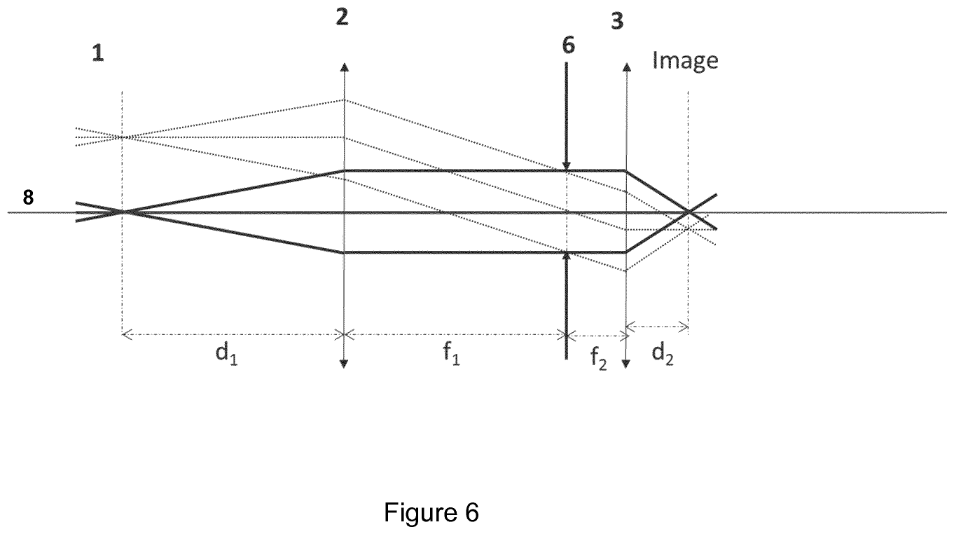

FIG. 6 schematically shows a doubly telecentric system created using the aperture stop 6. A system telecentric only in image space of the filter F or doubly telecentric can be produced in other manners well known to a skilled person in the art.

The system of FIG. 4 to 6 can alternatively be made telecentric by not including an aperture stop and instead including telecentric lenses for the object lens 2 or the image lens 3 or made doubly telecentric by including telecentric lenses for the object lens 2 and the image lens.

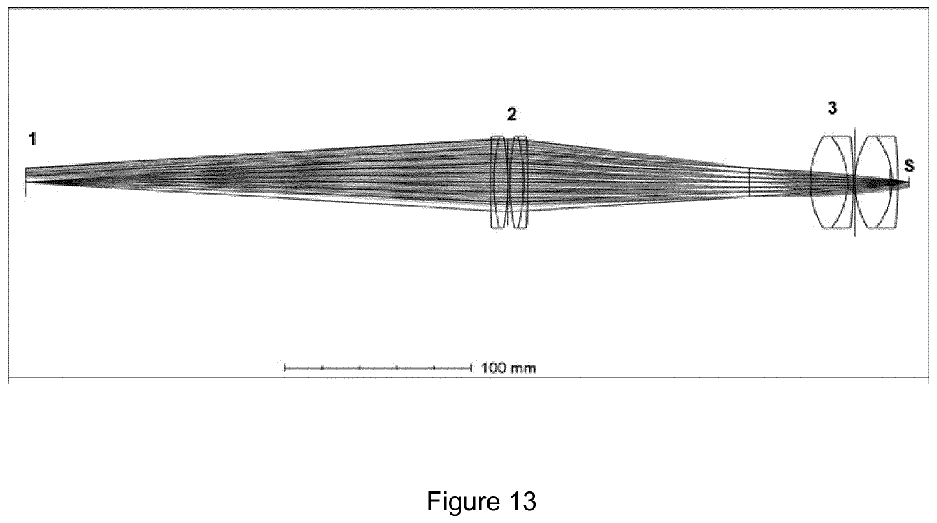

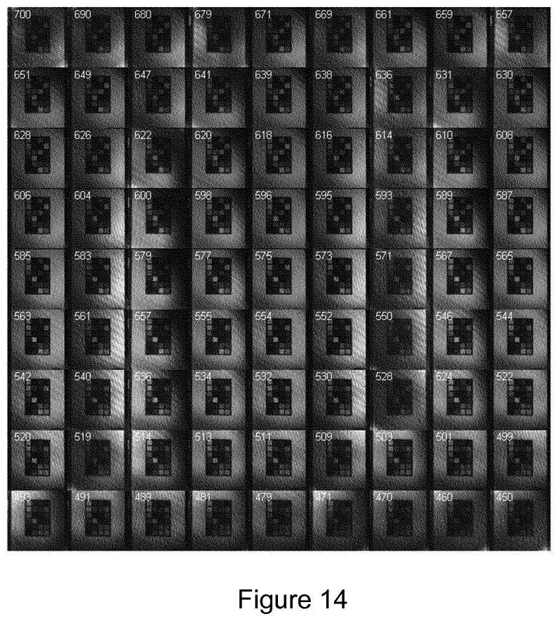

This is shown for example in FIG. 13. FIG. 13 shows system modeling in Zθₘₐₓ using a pair of achromatic lenses with long working distances. A preferred system includes long working Steinheil triplets at ×2 magnification. The sensor size was 4.6 mm (×2 magnification) and gave object of 9.2 mm. The image of the filter is diffraction limited and the spot size is less than 2 microns, i.e. less than a pixel.

The telecentric lenses are used in the object and image space to provide an orthographic projection producing the same magnification at all distances. Although an object 1 or image sensor S that is too close or too far from the lens may still be out-of-focus, the size of the resulting blurry image will remain (substantially) unchanged.

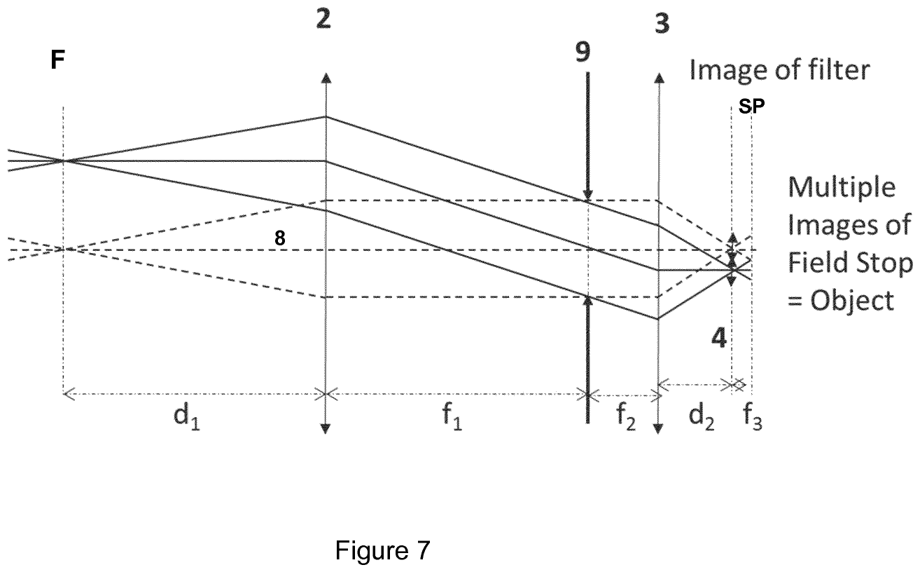

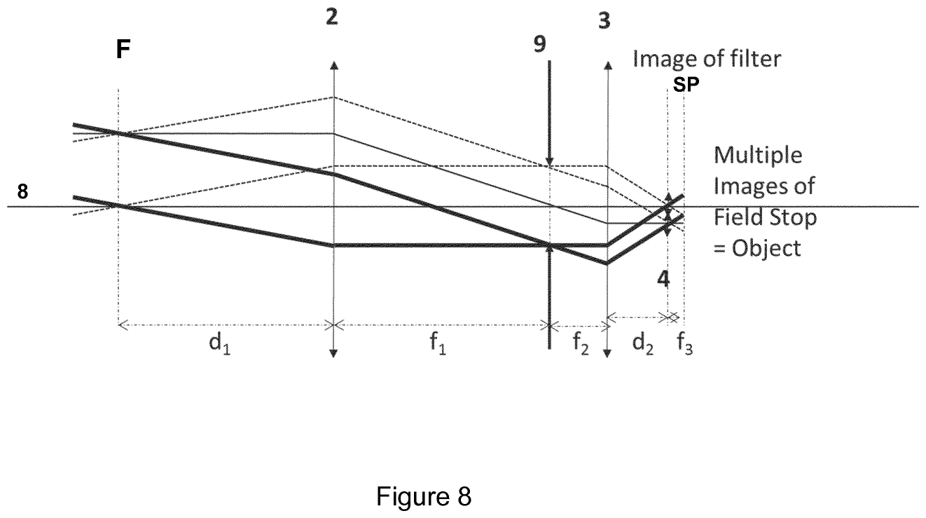

FIGS. 7 to 8 show another exemplary optical system configured to implement configuration B of FIG. 1h.

The optical system includes the objective lens 2, a field stop 9, image lens 3, the array 4 of image forming elements and the image sensor S.

This optical system is also configured to form a real image of the filter F on the array 4 of image forming elements to filter the multiple images i1 of the object 1.

The field stop 9 is positioned between the objective lens 2 and the imaging lens 3, and the array 4 of image forming elements is positioned between the imaging lens 3 and the image sensor S.

All elements are arranged along the optical axis 8. The image sensor S is not shown for clarity reasons but is represented by the sensor plane SP.

The lens 2 has a focal distance f₁, the lens 3 has a focal distance f₂ while the imaging forming elements of array 4 have a focal distance f₃. d₁ is the object distance from objective lens 2 and d₂ is the image distance where

$${d}_{2} = \frac{{f}_{2}}{{f}_{1}} ( {f}_{1} + {f}_{2} - \frac{{f}_{2}}{{f}_{1}} {d}_{1} )$$

and d₁ can range from 0 to

$$\frac{{f}_{2}}{{f}_{1}} ( {f}_{1} + {f}_{2} )$$

while d₂ ranges from

$$\frac{{f}_{2}}{{f}_{1}} ( {f}_{1} + {f}_{2} ) to 0.$$

The optical filter F can be (physically or materially) located at a position upstream (behind) from the objective lens 2 (as shown in FIGS. 7 and 8) or can be in contact with the objective lens 2 so that the filter F is imaged by the objective 2 and image lens 3 onto the array 4 of image forming elements (a real image of the filter is formed on the array 4). The object 1 (not shown) is also located at a position upstream (behind) from the objective lens 2.

The array 4 images an object 1 at a position upstream (behind) from the objective lens 2 onto the image sensor S (sensor plane SP) to provide a plurality of images i1 (FIG. 1h) of the object 1 at the image sensor S (sensor plane SP). The object 1 is not shown in FIGS. 7 and 8 for clarity reasons.

The optical filter F can alternatively be located downstream (in front of) from the array 4 between the array 4 and the sensor S, or upstream (behind) from the array 4 between the array 4 and the lens 3. The optical filter F can alternatively be located on the array 4 of image forming elements.

The array 4 of image forming elements is shown in the exemplary systems of FIGS. 7 and 8 located at the distance d₂ from the imaging lens 3 and at a distance f₃ from the sensor plane SP (sensor S). However, it is noted that this is not necessary for the system to function and the array 4 of image forming elements can be located about the distance d₂ from the imaging lens 3 and about the distance f₃ from the sensor plane SP (sensor S).

The field stop 9 is located (substantially) at or about the focal point f₁ of the objective lens 2 to control a distribution of light rays over a surface of the array 4 of image forming elements to control the perspective of the imaged object 1 allowing telecentric operation (telecentric in object space). The stop 9 is also located behind the second lens 3 substantially at or about the focal point f₂ of the second lens 3 (telecentric in image space) to create a doubly telecentric system limiting light rays from the object 1. This allows a doubly telecentric system to be created.

The optical system is telecentric with respect to the filter F and the image of the filter. The system is A-focal.

It is, however, not necessary that the system include the field stop 9. A system telecentric only in image space of the filter F or doubly telecentric can be produced in other manners well known to a skilled person in the art.

As mentioned above, the goal of this system of FIGS. 7 and 8 is to produce multiple images i1 of the object 1 as schematically shown in FIG. 1h. The array 4 is used to form multiple parallel images i1, and the filter F and filtering section FS is either placed just behind or in front of the microlens array 4 or on the array 4.

Alternatively, the filter F and filtering section FS is imaged onto the microlens array 4 as schematically shown in FIGS. 7 and 8. The filter F or a real image of the filter F is placed in the object space upstream from the lens 2, and the filter F or the real image of the filter F is imaged using lens 2 and lens 3 onto the array 4 as shown in the example of FIGS. 7 and 8.

FIG. 7 schematically shows a configuration to produce the multiple images i1 of the object 1 as schematically shown in FIG. 1h. The filter F is placed at the telecentric object position with respect to the lens 2 and lens 3. Rays from the same position at the filter F, e.g. solid lines, fill completely the field stop 9 and are imaged onto the array 4. Each element of the array 4 samples a certain part of the filter F. The same part of filter F is preferably never seen by more than one element of the array 4. FIG. 8 also shows the filter F placed at the telecentric object position with respect to lens 2 and lens 3. Rays from an object with the same angle in object space (e.g. bold line of FIG. 8) pass through the same point of the field stop 9 and each come to a focus with the same relative position behind array 4 and at the sensor plane SP creating a series of identical imagelets i1 of the object 1.

The system of FIGS. 7 and 8 can alternatively be made telecentric by not including the field stop 9 and instead including telecentric lenses for the object lens 2 or the image lens 3 or made doubly telecentric by including telecentric lenses for the object lens 2 and the image lens. Although an object 1 or image sensor S that is too close or too far from the lens may still be out-of-focus, the size of the resulting blurry images i1 will remain (substantially) unchanged. In any of the above described embodiments, the filter F can be physically located at the described positions of these optical systems. However, instead of physically placing the filter F in the system, a real image of the filter F can be used and located at the described positions of these optical systems.

Means for generating the real optical filter image and positioning the real optical filter image in the system is used in such a case. Such means include a converging lenses (a concave mirror can also be used), as long as the filter is placed further away from the lens (mirror) than its focal point then a real inverted image will be formed.

The array 4 of image forming elements and/or the objective lens 2 in any of the above described embodiments can be mounted in the system, for example on a translational mount or stage, to be mobile along the optical axis 8 to allow the spatial resolution of the optical system to be increased.

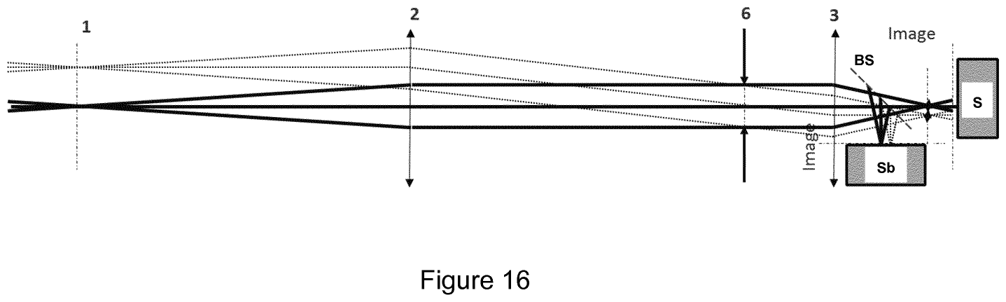

As shown schematically in FIGS. 16 to 18, the optical system of FIGS. 4 to 6 may include a beam-splitter BS to increase spatial resolution. Depending on the position of the beam-splitter BS in the system a third lens 3b and a second sensor Sb may be required as shown in FIGS. 16 to 18.

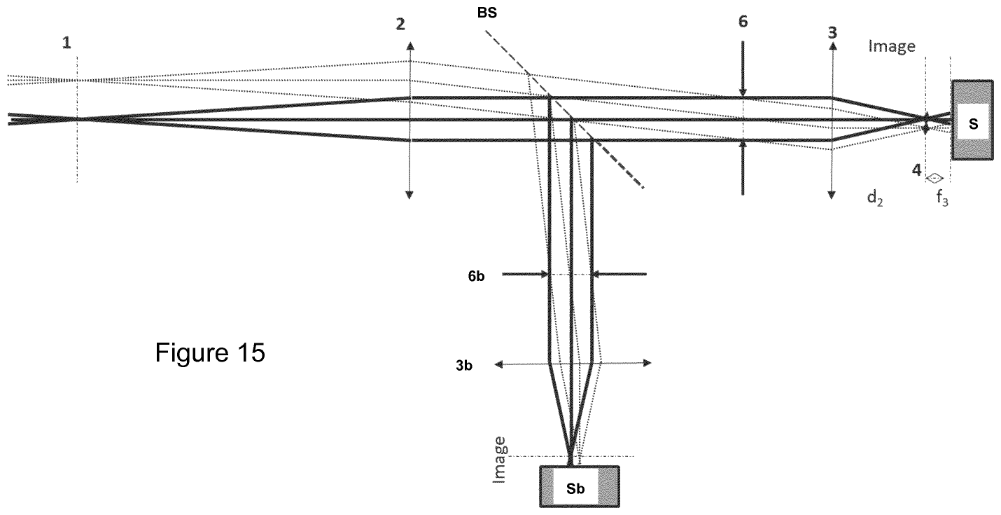

In FIG. 15, the beam-splitter BS is located between the objective lens 2 and the image lens 3 and a third lens 3b is arranged to image unfiltered incident light onto a second image sensor Sb. The beam-splitter is before filter F and the signal is unfiltered (therefore larger). A 10:1 splitter can for example be used.

In FIG. 16, the beam-splitter BS is located between the objective lens 2 and the array 4 of image forming elements and a third lens 3b is arranged to image filtered incident light onto a second image sensor Sb. As the beam-splitter is after the lens 3 the signal is filtered. This gives a summed transmission of the filter and useful information. Advantageously, no additional optical elements except the beam-splitter is required.

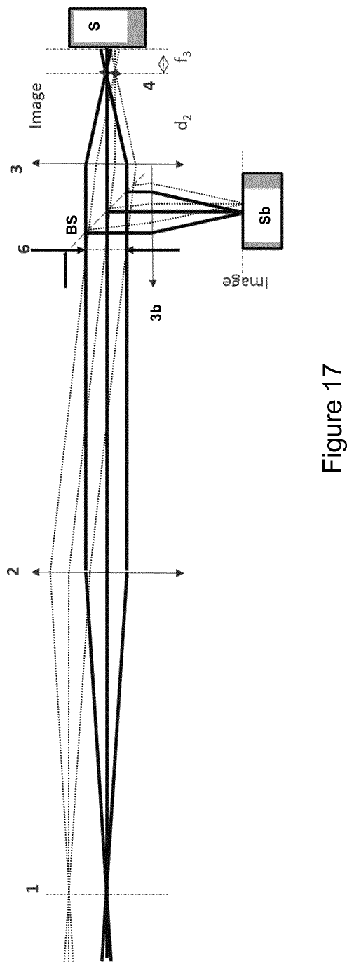

In FIG. 17, the beam-splitter BS is located between the filter F and the image lens 3 and a third lens 3b is arranged to image filtered incident light onto a second image sensor Sb. The beam-splitter BS is after the filter and thus the signal is filtered. This gives a summed transmission of the filter and useful information.

Although only shown with respect to the optical system of FIGS. 4 to 6, the beam-splitter BS and associated elements can also be used in the optical system of FIGS. 7 and 8 in the manner illustrated in FIGS. 4 to 6.

The inclusion of a beam-splitter in the optical system advantageously provides image enhancement and permits a higher spatial resolution to be obtained. A tradeoff exists between spatial and spectral resolution but the inclusion of a beam-splitter for a given spatial resolution can allow one to have a larger number of spectral channels compared to the case without a beam-splitter.

According to yet another aspect of the present disclosure, an optical system is provided for obtaining multi-/hyper-spectral hypercube measurements of an object.

That is, the present disclosure further concerns an optical system as described previously that permits the configuration B (such as that illustrated in FIG. 1h) to be achieved, wherein the optical system further includes a filter selection means FSM (or a filter selector) for selecting filtered electromagnetic radiation that is to be provided to the aperture array 4.

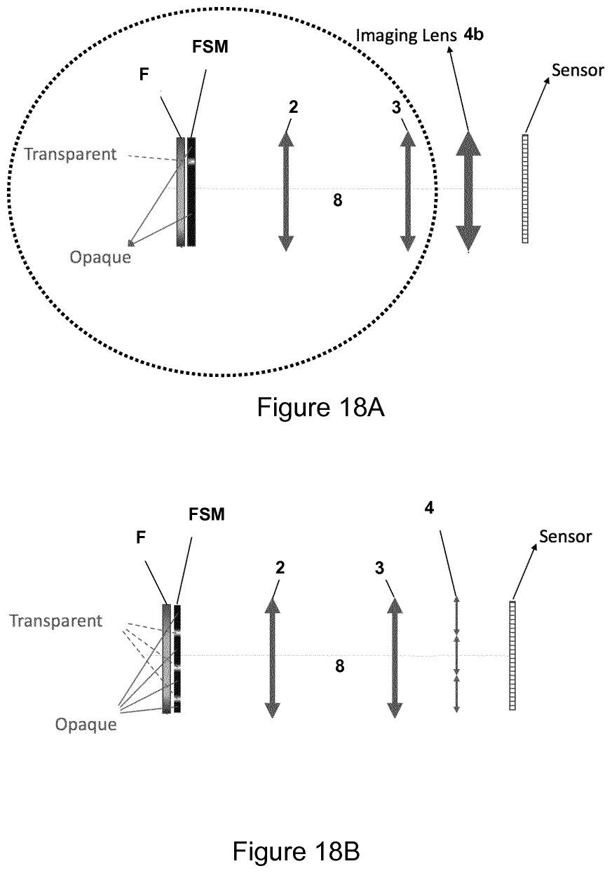

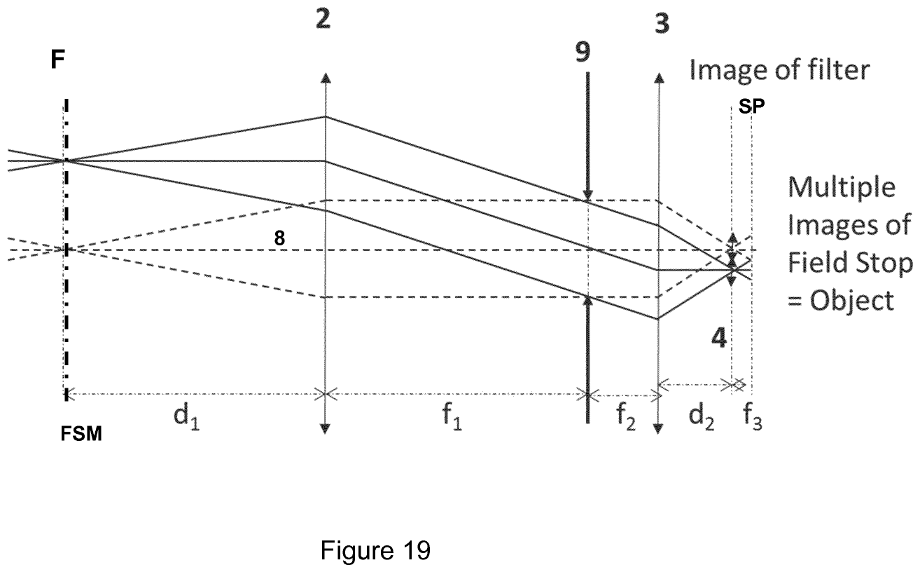

Exemplary embodiments are shown schematically in FIGS. 18A, 18B and 19. It is however noted that the optical system is not to be limited to the embodiments shown in FIGS. 18A, 18B and 19 but concerns any one of the embodiments described or illustrated in this disclosure in relation to an optical system permitting configuration B (such as that illustrated in FIG. 1h) to be achieved.

The optical system according to this aspect of the present disclosure, may include an imaging lens 4b instead of the aperture array 4. Moreover, while the optical system can include the filter F as previously described in the present disclosure, the optical system can alternatively include any optical filter F and does not necessarily have to include the filter F as previously described in the present disclosure containing for example a constant filtering direction. The optical filter can be, for example, a mosaic filter including a plurality of individual optical filters. The optical filter F can be configured to filter a plurality of wavelengths. Each individual optical filter of the mosaic filter can thus be, for example, configured to filter at a different wavelength.

The optical system can include at least one objective lens 2, an optical filter F, and an imaging lens 4b or the first aperture array 4 comprising a plurality of aperture elements such as image forming elements, for example, lenses, micro-lenses or pinholes.

The objective lens 2, the optical filter F, and the imaging lens 4b or first aperture array 4 are arranged along the optical axis 8 to form at least one projection or image of the optical filter F on the imaging lens 4b (For example, FIG. 18B) or on the first aperture array 4 (for example, FIG. 18B).

As previously explained in relation the configuration B, the projection or image of the filter F on the first aperture array 4 permits an object 1 (such as object i1 in FIG. 1h) to be simultaneously filtered at, for example, multiple wavelengths.

The object 1 is, for example, integrally (or wholly) and multiply replicated. The filter F is, for example, replicated once to filter each of the multiple integral or whole objects replications (for example, 16 whole object replications in FIG. 1h filtered by one filter image).

The projection or imaging has, for example, the same effect as if the filter F was physically placed in contact with the first aperture array 4.

For example, with respect to the exemplary 4×4 filter illustrated in FIG. 1h, the projection or image of this filter on the first aperture array 4 permits to simultaneously filter at 4×4 multiple or different wavelengths.

The optical system further includes filter selection means FSM that selects the filtered electromagnetic radiation that is to be provided to the imaging lens 4b or the aperture array 4.

The filter selection means FSM is configured to select the part of the filter F that will or that has already filtered light and this selected filtered light is imaged or projected by the system to or onto the imaging lens 4b or the first aperture array 4.

The filter selection means FSM can be located downstream from the filter (F), or can be located upstream from the filter (F).

The filter selection means FSM is configured to spatially select areas or zones of the filter F from which filtered light is received by the filter selection means FSM and passed through the filter selection means FSM (FSM downstream with respect to the filter F), or to spatially select areas or zones of the filter F to which light is then provided by the filter selection means FSM to the filter F and passed through the filter selection means FSM to be filtered by the filter F (FSM upstream with respect to the Filter F).

The filter selection means FSM may contact directly or indirectly the filter F. The filter selection means FSM can be attached directly or indirectly to the filter, but may also not be attached to the filter selection means FSM.

The imaging lens 4b is arranged in the optical system to form one projection of an object 1 on a second aperture array S or a second aperture array plane SP. The second aperture array S includes or is, for example, an image sensor S comprising a plurality of light sensing elements as previously mentioned above in the present disclosure.

The first aperture array 4 is arranged in the optical system to form a plurality of projections (imagelets) of the object 1 on the second aperture array S or the second aperture array plane SP. Multiple optical images are formed at the sensor plane SP or on the sensor S allowing multiple optical images to be captured simultaneously at the sensor plane SP.

The object 1 is located at a position upstream (behind) from the objective lens 2 but is not shown in the exemplary FIGS. 18A, 18B and 19 for clarity reasons. Light from the object 1 for example passes through the filter and the FSM to be imaged or projected by the imaging lens 4b or the first aperture array 4 onto the sensor array S or sensor plane.

As mentioned, the filter selection means FSM is configured to select a filtering zone or filtering zones of the filter F to select the filtered electromagnetic radiation to be provided to the imaging lens 4b or the first aperture array 4.

The filter selection means FSM can comprise a plurality of addressable areas configured to allow or block electromagnetic radiation through these areas to respectively allow or block electromagnetic radiation through the filter selection means FSM, from one side to the other.

The filter selection means FSM is, for example, configured to define at least one or a plurality of different patterns through which the electromagnetic radiation passes. The filter selection means FSM is, for example, configured to define a transparent band through which the electromagnetic radiation passes, and configured to define opaque areas or zones around the transparent band blocking the transmission of electromagnetic radiation. Only the transparent band allows electromagnetic radiation to pass through to the imaging lens 4b or the first aperture array 4.

The filter selection means FSM is configured for example to displace or sweep the transparent band to permit spectrum sweeping or to carry-out a push-broom scan.

The filter selection means FSM can be or comprise a spatial light modulator, for example, a liquid crystal spatial light modulator. The filter selection means FSM could alternatively be or comprise a Digital micro-mirror device (DMD).

The filter selection means FSM can comprise or consist solely of an electronically addressable optical device (or liquid crystal device) comprising a liquid crystal and a plurality of electronically addressable zones, areas or pixels containing the liquid crystal material. The device is configured to use the light-modulating properties of a liquid crystal to transmit or not transmit light through the device at each addressable zone, area or pixel of the device.

The filter selection means FSM can for example comprise or consist solely of a liquid crystal device or liquid crystal spatial light modulator LCD.

The liquid crystal device LCD can be, for example, attached to the filter F (such as a linear variable spectral filter) and directly or indirectly be in contact with the filter. The liquid crystal device LCD can be attached in an upstream position or alternatively attached in a downstream position as shown for example in FIGS. 18A and 18B.

Addressing different zones or areas or pixels on the liquid crystal device LCD to render them transparent (or at least partially transparent) or non-transparent (or at least partially non-transparent) allows one to change the pattern of transparent light on the liquid crystal device LCD permitting to choose the active part of the filter F and to choose the light provided by that part of the filter F for subsequent use.

FIG. 19 shows for example the optical system of FIG. 7 that further includes the filter selection means FSM. This same modification can be carried out to any one of the previously described embodiments concerning configuration B. As previously mentioned, the array 4 can be replaced by imaging lens 4b and the filter F is not limited to the filter previously described herein.

The system can be telecentric in image space and/or in object space. This can be achieved in the manner set out above in relation to configuration B.

For example. the objective lens 2 and/or the second lens 3 are telecentric lenses. A doubly telecentric lens system can be used to image the filter F-LCD pair onto the lens 4b or array 4 as illustrated, for example, in FIGS. 18A and 18B.

The whole frontend is equivalent of a colored lens with, for example, a color band equal to the integration of the filter F over the active part of the liquid crystal device LCD.

Thus, by imaging an object 1 while there are different patterns on the liquid crystal device LCD, a multi-/hyper-spectral hypercube measurement of the object 1 is achieved and obtained.

For example, if one puts a clear line on the liquid crystal device LCD aligned with the spectral bands of the filter F and set the liquid crystal device LCD opaque everywhere else, then by sweeping this clear line along the liquid crystal device LCD, one obtains a push-broom hyperspectral camera or system.

However, in contrast with the existing push-broom cameras or systems, there is no mechanically moving part. The advantages of such a push-broom camera is a system or camera providing high spatial and spectral resolution but without having the disadvantage of having a moving part. Also, since lots of different patterns can be mapped on the liquid crystal device LCD, one can perform multiple different measurements (not only simple spectrum sweeping) which results in more accurate and less noisy hypercube acquisition.

By using a microlens array 4 (see for example, FIG. 18B) instead of the single imaging lens 4b (see for example FIG. 18A), one obtains a combination of a push-broom camera and a snapshot camera. With this system, one advantagely obtain tens or hundreds of bands at each time of imaging. Thus, the total time of sweeping the entire spectrum divides by tens or hundreds. The combination of the push-broom and snapshot hyperspectral cameras thus gives the possibility to compromise between the advantages of these two types of cameras. Like push-broom cameras, one obtains high resolution in the spectral domain and like snapshot cameras one can trade speed with spatial resolution. Also, when one fixes the pattern on the liquid crystal device or LCD, this camera provides a snapshot hyper-/multi-spectral camera which has programmable bands.

The optical system described above can be provided as an add-on to an existing camera (cell phone, smart phone, camera, . . . ) to turn the exiting camera into a hyperspectral camera. In such a case, the add-on optical system preferably does not include the imaging lens 4b and/or the sensor array S and only, for example, the encircled part shown in FIG. 18A may be provided.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments, and be given the broadest reasonable interpretation in accordance with the language of the appended claims.

1-83. (canceled)

84. An optical system including:
at least one objective lens;
an optical filter; and
an imaging lens, or a first aperture array comprising a plurality of aperture elements;
wherein at least one objective lens, the optical filter, and the imaging lens or first aperture array are arranged along an optical axis to form at least one projection of the optical filter on the imaging lens or on the first aperture array, and wherein the optical system further includes a filter selection means for selecting filtered electromagnetic radiation to be provided to the imaging lens or the first aperture array.

85. System according to the previous claim 84, wherein imaging lens or the first aperture array is arranged in the optical system to form at least one projection of an object to be filtered on a second aperture array or a second aperture array plane.

86. System according to claim 84, wherein the filter selection means is configured to select a filtering zone or filtering zones of the filter to select the filtered electromagnetic radiation to be provided to the imaging lens or the first aperture array.

87. System according to claim 84, wherein the filter selection means comprises a plurality of addressable areas configured to allow or block electromagnetic radiation through said areas to respectively allow or block electromagnetic radiation through the filter selection means.

88. System according to claim 84, wherein the filter selection means is configured to define at least one or a plurality of patterns or polarizations through which the electromagnetic radiation passes.

89. System according to claim 84, wherein the filter selection means is configured to define a transparent band through which the electromagnetic radiation passes, and configured to define opaque areas or zones around the transparent band blocking the transmission of electromagnetic radiation such that only the transparent band allows electromagnetic radiation to pass through to the imaging lens or the first aperture array.

90. System according to claim 89, wherein the filter selection means is configured to displace or sweep the transparent band to permit spectrum sweeping.

91. System according to claim 89, wherein the filter selection means is configured to displace or sweep the transparent band to carry-out a push-broom scan.

92. System according to claim 84, wherein the filter selection means comprises or consists solely of an electronically addressable optical device comprising a liquid crystal and a plurality of electronically addressable zones, areas or pixels containing liquid crystal material or a Digital micro-mirror device (DMD).

93. System according to claim 84, wherein the optical system includes the first aperture array and the first aperture array includes an array of image forming elements comprising a plurality of lenses, micro-lenses or pinholes; and wherein the first aperture array is arranged in the optical system to form a plurality of whole or integral replications of an object on a sensor plane or a sensor; and wherein the filter is imaged to form the at least one projection of the filter on the first aperture array to filter the plurality of object replications.

94. System according to claim 84, wherein the optical filter comprises or is a mosaic filter including a plurality of individual optical filters.

95. System according to claim 84, wherein the optical filter is configured to filter the same wavelength along a constant filtering direction of the filter and wherein the optical filter includes a filtering section, the filtering section defining an incident surface area, the filtering section including the constant filtering direction and being further configured to continuously filter at different wavelengths along a direction of the incident surface area following a vertical direction to the constant filtering direction.

96. System according to the previous claim 95, wherein a filtering section is further configured to continuously filter at different wavelengths along any direction or all directions non-parallel to the constant filtering direction across the incident surface area.

97. System according to claim 84, wherein the system comprises the objective lens, a second lens, and the array of image forming elements or the imaging lens respectively arranged along the optical axis, wherein the optical filter and the filter selection means are located at a position upstream from the objective lens so that the filter is imaged by the objective and the second lens onto at least a part of the array of image forming elements or the imaging lens; and the array of image forming elements or the imaging lens images an object onto an image sensor plane to provide at least one or a plurality of images of the object at the image sensor plane; or wherein the optical filter and/or the filter selection means are placed in front or behind or on the array of image forming elements or the imaging lens.

98. System according to claim 84, wherein the system comprises the objective lens, a field stop, a second lens and the array of image forming elements or the imaging lens respectively arranged along the optical axis, wherein the optical filter and the filter selection means are located at a position upstream from the objective lens or with the filter in contact with the objective lens so that the filter is imaged by the objective and second lens onto at least a part of the array of image forming elements or the imaging lens; and the array of image forming elements or the imaging lens images an object onto an image sensor plane to provide a plurality of images of the object at the image sensor plane.

99. System according to claim 84, wherein the system comprises the objective lens, a field stop, a second lens, the array of image forming elements or the imaging lens respectively arranged along the optical axis, wherein the optical filter and/or the filter selection means are located in front of, behind or on the array of image forming elements or the imaging lens.

100. System according to claim 84, wherein the system is telecentric in image space and/or in object space.

101. System according to claim 84, wherein the array of image forming elements and/or the objective lens are mounted to be mobile along the optical axis to allow the spatial resolution of the optical system to be increased.

102. Device including the optical system according to claim 84, wherein the device is a telephone or smart phone.

103. System including a smartphone and the optical system according to claim 84 provided as an add-on device for the smartphone.
